(19) United States
(12) Patent Application Publication
(10) Pub. No.: US 2026/0349900 A1
(43) Pub. Date: Nov. 5, 2026

(54) HUMAN PROXY AGENT FOR TESTING ARTIFICIAL INTELLIGENCE AGENTS

(71) Applicant: SAP SE, Walldorf (DE)

(72) Inventors: Max Spannagel, Mannheim (DE); Jonathan Von Rueden, Wiesbaden (DE); Sebastian Baechle, Homburg (DE); Thomas Ritter, Berlin (DE); Matthias Roos, Saarbruecken (DE)

(21) Appl. No.: 19/298,676

(22) Filed: Aug. 13, 2025

Related U.S. Application Data
(60) Provisional application No. 63/798,823, filed on May 2, 2025.

(51) Int. Cl. G06F 11/34; G06F 8/30

(52) U.S. Cl. CPC G06F 11/3414; G06F 8/30

(57) ABSTRACT

In an example embodiment, a human proxy agent (HPA) is generated by an LLM based on process descriptions. These process descriptions, also referred to as scenarios or test data, are employed for two primary purposes: first, to extract fictitious personas from the descriptions, and second, to ground these personas in the process knowledge. A persona is defined as a hypothetical user representing a group of similar users. In essence, these HPAs respond in a manner consistent with a real person who has knowledge of the process. The HPA is then used to test an interview AI agent that is being used to generate process descriptions for AI agents.

### CROSS-RELATION TO RELATED APPLICATIONS

This application claims priority to U.S. Provisional Application No. 63/798,823, filed May 2, 2025, entitled “HUMAN PROXY AGENT FOR TESTING ARTIFICIAL INTELLIGENCE AGENTS AND ARTIFICIAL INTELLIGENCE AGENTS BUILDING ARTIFICIAL INTELLIGENCE AGENTS,” hereby incorporated herein by reference in its entirety.

### TECHNICAL FIELD

Embodiments pertain to artificial intelligence and, in some examples, to a human proxy agent for testing an artificial intelligence agent.

### BACKGROUND

In enterprise environments, artificial intelligence (AI) systems are designed to interact with users and other systems perform tasks, make decisions, and process information. AI agents often rely on large language models (LLMs) to understand and generate human-like text, enabling them to engage in natural language interactions.

AI agents are autonomous computer programs that can perceive their environment, make decisions, and take actions to achieve specific goals. They are built to operate with little to no human guidance and are often driven by artificial intelligence techniques like machine learning, logic, or planning. These agents are designed to understand what's happening around them—whether it's through sensors, user interactions, or data from the internet—and respond in ways that help them accomplish tasks.

### BRIEF DESCRIPTION OF THE DRAWINGS

The present disclosure is illustrated by way of example and not limitation in the figures of the accompanying drawings, in which like references indicate similar elements.

FIG. 1 is a diagram illustrating a system for building AI agents, in accordance with an example embodiment.

FIG. 2 is a block diagram illustrating an AI agent in more detail, in accordance with an example embodiment.

FIG. 3 is a block diagram illustrating an interview AI agent 120, in accordance with an example embodiment.

FIG. 4 is a block diagram illustrating execution of a baseline model, in more detail.

FIG. 5 is a block diagram illustrating a one-prompt agent, in accordance with an example embodiment.

FIG. 6 is a block diagram illustrating a modularized model, in accordance with an example embodiment.

FIG. 7 is a block diagram illustrating a resolver model, in accordance with an example embodiment.

FIG. 8 is a block diagram illustrating a summaries model, in accordance with an example embodiment.

FIG. 9 is a flowchart illustrating a method, according to some examples, of conducting an automated interview to extract process knowledge and generate a process description.

FIG. 10 is a flow diagram illustrating a method for generating and using an HPA, in accordance with an example embodiment.

FIG. 11 illustrates a machine learning system, according to some examples.

FIG. 12 is a flowchart depicting a machine learning pipeline, according to some examples.

FIG. 13 is a system architecture diagram showing a layered view of an AI integrated system, according to some examples.

FIG. 14 shows a block diagram showing one example of a software architecture for a computing device.

FIG. 15 shows a block diagram of a machine in the example form of a computer system within which instructions may be executed for causing the machine to perform any one or more of the methodologies discussed herein.

### DETAILED DESCRIPTION

The description that follows discusses illustrative systems, methods, techniques, instruction sequences, and computing machine program products. In the following description, for purposes of explanation, numerous specific details are set forth to provide an understanding of various example embodiments of the present subject matter. It will be evident, however, to those skilled in the art, that various example embodiments of the present subject matter may be practiced without these specific details.

The described examples focus on the use of artificial intelligence (AI) agents to automate tasks and processes in enterprise environments. These agents are software entities that operate autonomously to perform tasks, make decisions, and interact with users or other systems. They are designed to understand and process natural language, enabling them to engage in conversations and execute actions based on user input or predefined rules.

The described examples rely on large language models (LLMs) as a core component. LLMs are advanced AI systems trained on vast amounts of text data. They can generate human-like text and understand complex language patterns. This capability allows them to interpret user instructions, generate responses, and perform tasks that require language comprehension. LLMs are used in various applications, including content generation, customer service, and decision support. In enterprise settings, AI agents are often integrated into workflows to assist with repetitive or complex tasks. These tasks may include data entry, document summarization, or process automation. The agents can interact with users through natural language interfaces, such as chatbots or virtual assistants. They can also connect to external systems, such as databases, APIs, or software tools, to retrieve or process information.

One challenge in deploying AI agents is the need to accurately capture and represent organization processes. Organization processes are sequences of activities that achieve specific goals, such as approving a vacation request or processing an invoice. These processes often involve multiple steps, decision points, and dependencies. In order to automate these processes, AI agents must understand the sequence of steps, the criteria for decisions, and the relationships between activities.

Another challenge is the extraction of process knowledge from users or existing documentation. Process knowledge may be explicit, such as written guidelines or process models, or implicit, residing in the experience of employees. There currently exist no technological mechanisms to aid in the acquisition of such implicit process knowledge.

In an example embodiment, an AI agent is provided that builds other AI agents. More specifically, the AI agent is designed to conduct an interview with a human in a manner that extracts contextual and domain knowledge regarding one or more tasks to be performed in an organization. The AI agent may then use this extracted knowledge to create one or more AI agents to actually perform the tasks of the organization.

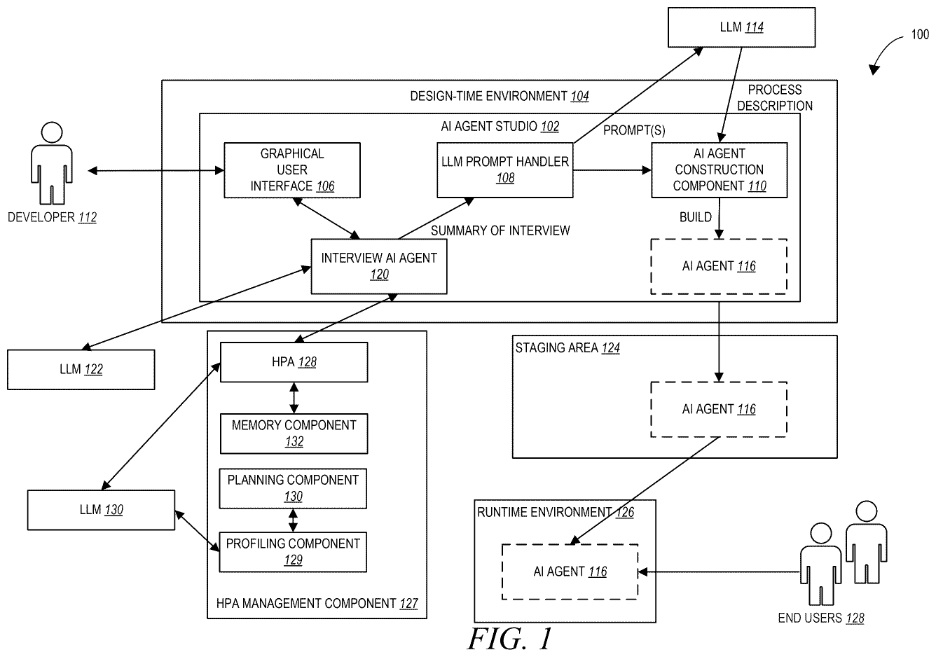

FIG. 1 is a diagram illustrating a system 100 for building AI agents, in accordance with an example embodiment. Here, an AI agent studio 102 is provided within a design-time environment 104. One example AI agent studio is the Joule Studio™ from SAP SE, of Hamburg, Germany. The AI agent studio 102 is a software program that allows for creation of an AI agent. The AI agent studio 102 comprises a graphical user interface 106, an LLM prompt handler 108, and an AI agent construction component 110. Traditionally a developer 112 would interact directly with the graphical user interface 106 to generate one or more prompts directing the AI agent studio 102 as to what type of AI agent to construct and how. The LLM prompt handler 108 would then send these prompts to an LLM 114, which would then return output that is used by the AI agent construction component 110 to actually build the AI agent, such as AI agent 116.

In an example embodiment, however, rather than interacting directly with the graphical user interface 106 to generate the one or more prompts for the LLM prompt handler 108, the developer 112 interacts with the graphical user interface 106 to answer interview questions generated by an interview AI agent 120. The interview AI agent 120 itself acts to generate the one or more prompts for the LLM prompt handler 108. This is accomplished by the interview AI agent 120 itself interacting with an LLM 122 to determine the interview questions and responses. It should be noted that while in FIG. 1 LLM 114 and LLM 122 are depicted as different LLMs, in some example embodiment they may be the same LLM.

The LLM prompt handler 108 then prompts the LLM 114 based on the prompts generated by the interview AI agent 120. The output from the LLM 114 is then used by the AI agent construction component 110 in constructing the AI agent 116.

More specifically, the AI agent construction component 110 uses this input, as well as other contextual information such as process descriptions, either text-based or in graphical form such as Business Process Model and Notation (BPMN) format, to build the AI agent 116. The AI agent construction component 110 interprets all the input and generates a Core Data Services (CDS) model describing the AI agent 116. The CDS model includes the definition of entities, their relationships, and data types. This model forms the backbone of the AI agent's structure.

Once the data model is established, the AI agent construction component 110 acts to generate the necessary application logic. This can include crafting Node.js code to handle business operations such as Create, Read, Update, Delete, and Query (CRUD+Q) events. This application logic represents the AI agent 116, which can be presented in a staging area 124, allowing developers to review and refine the code as needed. The staging area 124 is also where the AI agent 116 can be tested.

The application logic generated by the AI agent construction component may include a sequence of operations that may utilize one or more software tools. These tools may include, for example, a calendar tool. The AI agent may automatically interact with these tools at runtime. As such, the one or more software tools accessible by the AI agent may be selected during application logic construction and references to those tools may be specified in the deliverable that is actually executed at runtime.

In some example embodiments, the developer 112 may select the one or more tools and the AI agent construction component 110 may generate the necessary application logic, based on the input from the LLM 114, to utilize the selected one or more tools.

In other example embodiments, the AI agent construction component 110 itself may select the one or more software tools automatically, based on the input from the LLM 114. This may be performed in a number of different ways. In one example embodiment, a vector search may be used to compare a vector embedding of the input from the LLM 114 to vector embeddings of tool descriptions stored in a vector database. Matching tools may then be automatically selected by the AI agent construction component 110.

In another example embodiment, a separate LLM may be used to select the best tools based on the tool descriptions.

Once the AI agent 116 is built and tested, it is transferred to a runtime environment 125 where it can be executed in response to requests from end users 126.

AI agents utilize advanced technologies, such as LLMs and deep learning, to enhance contextual understanding and evaluate diverse courses of action, selecting the optimal option. In contrast to traditional machine learning methods, which require training for new and unseen scenarios, AI agents can solve these scenarios based on their general understanding of the environment without further training. This attribute makes them particularly strong in human-level decision making, especially in domain-independent problems.

LLMs in AI agents are distinguished by their capacity to adapt to a variety of tasks, thereby demonstrating a high degree of generalizability. Furthermore, LLMs are able to understand contexts, make decisions, and understand their environment based on natural language. Agents that utilize LLMs are capable of developing more sophisticated strategies for problem-solving and implementing them with the tools at their command. This distinguishes them from rule-based approaches, which are constrained to a fixed scope and are therefore applicable when the answer requires a complex decision-making process or when real-time responses are expected.

In the context of LLM-based agents, the LLM takes on the role of a controller that has decision-making and strategy capabilities. In the next step, based on the text or instructions generated by the LLM, actions can be performed and decisions can be made, which, due to the linguistic abilities of LLMs, come close to the human complexity of thinking, reasoning and deciding. LLMs are characterized by three main features.

First, LLMs profound understanding of natural language enables them to understand, generalize, and respond to a wide range of user queries. The utilization of natural language as the interface between agents and their environment makes the interaction with humans more understandable and as simple as possible, which in turn increases the transparency and explainability of the entire system.

Second, the content of their context window enables LLMs to engage with extended interactions and respond accordingly. This capacity enables them to comprehend intricate plans and formulate more precise responses that are anchored in prior interactions or actions.

Third, the data to be processed and the decisions to be made are often text-based, either in the form of instructions or by formulating code or API requests that trigger the corresponding decisions in external systems. AI Agents can be classified into four categories based on their nature and properties, although in reality there is a large overlap among the categories. The fundamental attribute that defines an AI agent is its capacity to perceive its environment and subsequently take action, a capability that is consistent across all AI agents.

Reactive or simple-reflexive agents are defined as agents that function in accordance with the perception-action-communication-organization (PACO) principle. The flow of information within this paradigm plays a pivotal role: a perception from the environment triggers an action, which is communicated via predefined communication channels. The implementation of PACO-based agents is characterized by a rigid assignment T:S→A of stimulus s∈S to action a∈A, a characteristic that makes them less intelligent. Consequently, these agents encounter challenges in scenarios involving unseen stimuli or actions with a high degree of complexity and interconnection.

Here, T represents a function or mapping that assigns each possible stimulus to a specific action. The notation T:S→A indicates that T is a function taking an element s from the set of possible stimuli S and mapping it to an element a in the set of possible actions A. The variable s, which belongs to S, stands for a specific stimulus or perception that the agent receives from its environment. The set S encompasses all possible stimuli the agent might encounter. The variable a, which belongs to A, represents a specific action that the agent can perform, with A being the set of all possible actions available to the agent.

Within this framework, the agent perceives its environment and receives a stimulus s. The function T then determines the corresponding action a that the agent should take in response to that stimulus. This mapping is rigid, meaning that for every possible stimulus, there is a predetermined action, and the agent does not adapt or learn new mappings on its own.

The stimulus s always originates from the agent's perception of the environment, and the action a is the agent's response, which is communicated or executed according to the predefined mapping T. Because this mapping is fixed and does not change based on experience or context, reactive agents are limited in their ability to handle new, complex, or interconnected situations. They simply react to environmental inputs in a predetermined way, without reasoning or adaptation.

In addition to the PACO principle, memory-based agents emphasize a high level of information processing, enabling them to discern complex patterns. These agents employ sophisticated memory. The sophisticated storage and retrieval processes enable the consideration of past events and conditions.

Goal-based agents utilize planning and reasoning capabilities to pursue a specific objective through their actions. These agents augment the capabilities of memory-based agents by leveraging their properties to formulate intricate plans and decompose them into discrete tasks. Furthermore, they possess the capacity to utilize past experiences to assess their own action strategy and, when necessary, discard it if it has yielded unfavorable outcomes in the past.

Finally, utility agents represent the most sophisticated category within this taxonomy. Utility agents adopt a similar approach to goal-based agents, but introduce utility functions that enable forward-looking consideration of potential actions. Utilizing tools or knowledge, these agents can assess potential outcomes, simulate them, and thereby evaluate them. This capacity enables them to make decisions based on more than just experience when choosing an option for action, and to act in a self-reflective manner. The challenge of this model lies in the complicated trade-off between “immediate utility and long-term value.

As mentioned earlier, LLMs are used to implement many modern AI agents. In addition to the aforementioned points, LLMs exhibit four characteristics that qualify them for use in autonomous agents: autonomy, reactivity, sociality, and proactivity.

Autonomy signifies the capacity of LLMs to function independently, without the need for direct human or external intervention. This implies that they continuously observe their environment and make decisions based on these observations. AI Agents do not merely adhere to initial instructions but also need to initiate actions on their own. This capacity is demonstrated, e.g., by the ability of LLMs to generalize problems to other cases and to use natural language to generate actions in pursuit of a goal. LLMs can adapt their output to different environments and conditions without being trained or defined for each specific case. This capacity closely approximates human independence.

The capacity to react to changes in the environment is a defining feature of LLM-based agents. LLMs are also distinguished by their rapid processing speed, which is not dependent on lengthy training or computation processes for each use case. This property is of particular relevance in systems with real-time applications that necessitate a quick response. The impact of prior experiences on the reactivity of these agents is a crucial consideration.

Interaction with humans is an integral component of LLMs'social skills. In this context, the term human-in-the-loop is often used to denote the integration of human expertise into the agent's decision-making process at specific points. This happens, for example, when critical actions are required to be confirmed, such as sending an email to a customer or changing an invoice amount. In such instances, the human is presented with suggestions, which they can then either accept, inquire about, or choose to execute. However, the social ability extends beyond the human-in-the-loop paradigm. In the handling of complex problems, group dynamics, social structures, and the coordination of multiple agents play a central role in achieving solutions. LLM-based agents are capable of communicating with other LLM-based agents via natural language, articulating concerns, and exchanging results. This approach closely approaches the simulation of a group of experts, where each agent has specific strengths and the problem can only be solved jointly through consultation and iteration.

Lastly, LLM-based agents exhibit proactivity, which distinguishes them from reflexive agents that base their decisions solely on their environment. This assertion may initially appear paradoxical, given that agents appear to be constrained by the principle of autoregressive completion. However, the employment of prompt engineering techniques in the past has been able to overcome this. These techniques involve the design of system prompts or simple prompts to ensure that an LLM performs a task as closely as possible to user expectations. Specifically, prompts that elicit an LLM to decompose problems or process information sequentially have yielded solutions that diverge significantly from analogous cases. In these cases, the generalization capability of LLMs becomes a key factor.

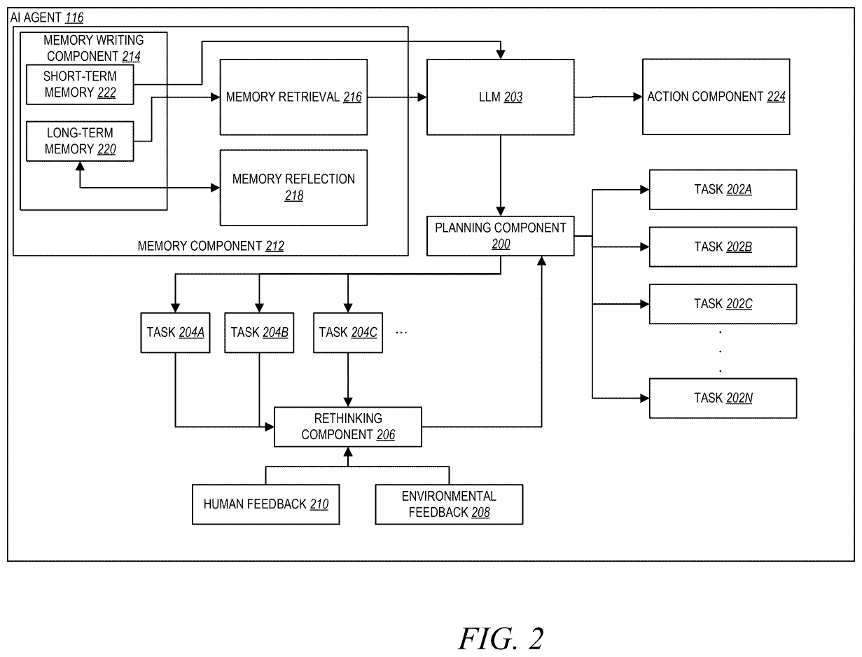

FIG. 2 is a block diagram illustrating an AI agent 116 in more detail, in accordance with an example embodiment. Here, the AI agent 116 comprises a planning component 200 and a series of tasks, such as task 202A, task 202B, task 202C, . . . , task 202N. The planning component 200 is controlled by the LLM 203 and controls the remaining components. In the AI agent 116. The planning component 200 anchors the AI agent 116 in its environment, enabling it to formulate plans for subsequent actions within the environment. The planning component 200 is able to analyze a current situation through observations and then select and weigh potential actions. It is then able to select the optimal action from these potential actions. As part of this process, task decomposition may be performed. The objective of task decomposition is to break down an action into smaller tasks and create a plan for their execution. In this process, the connection between the original action and the tasks are not lost to ensure that the tasks are goal oriented. The execution of the tasks then results in the realization of the action.

The execution of task decompensation is facilitated by reasoning or thinking strategies. A distinction is made between single-path reasoning or multi-path reasoning, such as chain-of-thought or graph-of-thought, respectively. A commonality between these approaches is the assumption that the solution strategy of a task can be conceptualized as a linear or graph-based chain of individual steps. A particular manifestation of the graph-of-thought is the tree-of-thought, which delineates problems in the form of a directed, cycle-free, and connected graph. Nevertheless, a reasoning model used by the planning component 200 may utilize the chain-of-thought approach as numerous problems—particularly those of a logical nature—can be decomposed into multiple steps that build on each other.

The implementation of a chain-of-thought can be achieved through prompt engineering or few-shot learning methodologies. In the context of few-shot learning, a potential solution to a given problem is presented to an LLM 203 in the prompt, with the objective of aligning the output with the desired form. This process is done, for example, by a few input-output exemplars demonstrating the task. The LLM then generalizes the provided solution and transfers it to the actual problem. In contrast, zero-shot learning does not involve the provision of any examples to the LLM.

Apart from these planning strategies that operate without feedback, in which the LLM 203 autonomously executes the task decompensation and is accepted without additional control, there are also strategies that function with feedback. One such strategy is depicted in FIG. 2. Specifically, tasks such as task 204A, task 204B, and task 204C may be re-examined using a rethinking component 206. This approach can be referred to as plan reflection or rethinking, and can be executed automatically or manually. It is particularly appropriate when the tasks are particularly complex or when the plan must meet certain criteria, such as the use of certain tools, compliance regulations, or best practices. In this context, environmental feedback 208, which is automatically generated from the agent's environment, can be incorporated. Alternatively, the AI agent can be given the opportunity to react to feedback. For instance, when creating source code, an agent can react to an error message indicating that a certain Python library is unavailable by restructuring the plan to access alternative resources. The Reasoning+Acting (ReAct) framework exemplifies this approach. The ReAct framework combines reasoning and acting by building an execution plan based not only on the task, but also on observations of the environment.

Another form of control is provided by human feedback 210. Humans in the loop can approve a plan before its execution or highlight potential weaknesses that the agent can address and revise in real time.

In order to ensure the continuous evaluation of the execution plan, as exemplified by the ReAct framework, and to adequately process environmental perception, the agent must be able to remember things. In LLM-based agents, this capacity is facilitated by a memory component 212 that stores past observations, thoughts, and actions. This capacity enables agents to gather experience, self-learn, and act in a more reasonable and effective manner. The memory component 212 is comprised of three sub-components: memory writing component 214, memory retrieval component 216, and memory reflection component 218.

The memory writing component 214 may contain both long-term memory 220 and short-term memory 222.

The short-term memory 222, for instance, can include the ongoing course of a conversation, preceding or subsequent planning steps, or the current task. In the context of a chatbot, for instance, this could be the current chat conversation. The AI agent's current decisions are based on these short-term memories.

Conversely, the long-term memory 220 contains experiences from past decision-making processes or guidelines, as well as information that only needs to be considered in certain situations.

The transfer of information from the short-term memory 222 to the long-term memory 220 is not a direct one-to-one process. Rather, the long-term memory 220 is first reviewed, summarized and scanned for duplicates. This process effectively circumvents two significant challenges posed by the memory component 212: memory duplication and memory overflow.

The process of memory reading using the memory retrieval component 216 is dependent on the type of memory. The capacity of the short-term memory 222 is constrained by the size of the context window. Given its direct impact on subsequent tokens of the generated content, its influence is particularly strong. Retrieval is inherently guaranteed, yet it can be further reinforced through prompt engineering techniques. Memory reading or retrieval is particularly challenging for long-term memory 220 because of the large amount of information that must be considered, much of which is likely to be of little relevance to the current task. Given the limited scope of context windows, the integration of all content within the context of the LLM is not a viable option.

The identification of useful memories is therefore typically characterized by three criteria: recency, relevance, and importance.

In order to improve such memory reading, in an example embodiment, vector embeddings may be used. A vector embedding is a set of coordinates in a latent n-dimensional space such that the proximity (e.g., cosine distance) of the coordinates to other coordinates is indicative of the similarity of the information embedded to those coordinates. In an example embodiment, the embedding is a high-dimensional (e.g., 1536-dimension) floating point vector, and the texts with similar semantics will have the corresponding similar embeddings. Vector embeddings may be formed by transforming (also known as “embedding”) data, such as text descriptions into the vector representations (also known as “embeddings”). This may be performed using, for example, a specialized machine learning model called an embedding machine learning model.

Specifically, an embedding machine learning model is trained on a large corpus of text and then used to perform the embedding of the underlying text into embeddings. This allows similar pieces of text to be identified even from text that is different. For example, text including the term “apartment” may be similar to text including the term “flat”, even though their words are completely different. Thus, the embeddings for these two words may be geometrically close to each other in the latent n-dimensional space.

The embedding machine learning model may be trained by any model from among many different potential supervised or unsupervised machine learning algorithms. Examples of supervised learning algorithms include artificial neural networks, Bayesian networks, instance-based learning, support vector machines, linear classifiers, quadratic classifiers, k-nearest neighbor, decision trees, and hidden Markov models.

In an example embodiment, the embedding machine learning algorithm used to train the machine learning model may iterate among various weights (which are the parameters) that will be multiplied by various input variables and evaluate a loss function at each iteration, until the loss function is minimized, at which stage the weights/parameters for that stage are learned. Specifically, the weights are multiplied by the input variables as part of a weighted sum operation, and the weighted sum operation is used by the loss function.

In some example embodiments, the training of the machine learning model may take place as a dedicated training phase. In other example embodiments, the embedding machine learning model may be retrained dynamically at runtime based on feedback.

Performing a similarity search using such vector embeddings results in efficient retrieval of data.

The content of the long-term memory 220 can be divided into meaningful units (chunking), and each of these is converted into a vector representation that reflects the context of the content. Consequently, a similarity search can be employed to transfer content that is most relevant to the current task into the context window.

This approach ensures that only relevant memories are displayed in the context window, while still taking a large amount of information into account. A notable advantage of this approach is its ability to integrate not only experience-based content, but also APIs, databases, or the Internet.

The memory reflection component 218 enables the AI agent to rethink its own behavior based on its memories and to draw new conclusions from them. This process enables the AI agent not only to validate its own actions with the help of its memory, but also to draw new conclusions, e.g. by summarizing its own actions. The process of memory reflection can result in the generation of content that is subsequently transferred to long-term memory, where it becomes available for retrieval. For, at the conclusion of an interaction with a human, an AI agent could recognize the person's tone, manner, or language style and adapt to it in the future. Alternatively, the agent can learn domain-specific terminology that it will use in the future.

The action component 224 is responsible for translating the AI agent's intentions into tangible actions within its environment. The action is the result of observations, the planning component 200 and the memory component 212 serve to fulfill the agent's goals directly or indirectly. This action can be executed in one of two ways: either by directly executing the actions required to fulfill the task or a subtask, or indirectly, either by exploring the environment or by communicating with other agents or humans. The action component 224 is also responsible for calling one or more software tools upon execution of the underlying tasks. This aspect will be described in more detail below.

It is important to note that the nature of an action does not always have to be that of an actuator but can also be that of a sensor. For example, prior to composing and sending an email to fulfill a task, an AI agent may consult various systems or APIs to gain a comprehensive understanding of the context, or alternatively, seek guidance from a human before proceeding with the email. It is possible to think of each execution of a planning step as an action. These actions may be executed iteratively until the desired outcome is achieved.

These tools also serve to expand the parameterized knowledge of an LLM. Due to the extensive training required, the knowledge of LLMs is subject to a so-called knowledge cutoff. This cutoff delineates a point in time at which the training process of the LLM has incorporated current information into the LLM's parameters.

Given the importance of extending parameterized knowledge with non-parameterized knowledge, especially in a business context, tools are used to integrate this knowledge into the agents.

Whenever an action is to be carried out that goes beyond pure internal text processing with parameterized knowledge, this can be implemented with the help of other tools. Examples of such tools include the internet or internal sources using Retrieval Augmented Generation (RAG), API endpoints to other systems, code interpreters, and calculators that successively expand the functionality of LLMs.

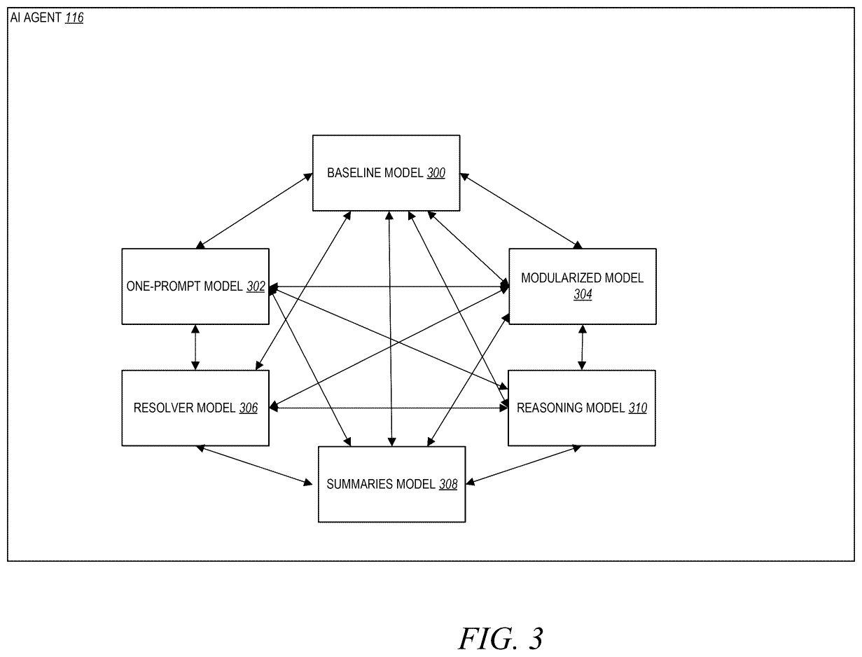

Referring back to FIG. 1, the interview AI agent 120 may actually comprises a plurality of different interview AI agents. FIG. 3 is a block diagram illustrating an interview AI agent 120, in accordance with an example embodiment. This may include a baseline model 300, a one-prompt model 302, a modularized model 304, a resolver model 306, a summaries model 308, and a reasoning model 310. These models are designed to at least be partially based on each other, thus enabling the drawing of conclusions about the effects of the differences between them.

The baseline model 300 facilitates a comparison with an interview process not using an LLM. The baseline model 300 may conduct a structured interview based on a set number (e.g., five) of predefined questions. After all the questions have been asked, an LLM may summarize the process, but the questions themselves are not formed with an LLM.

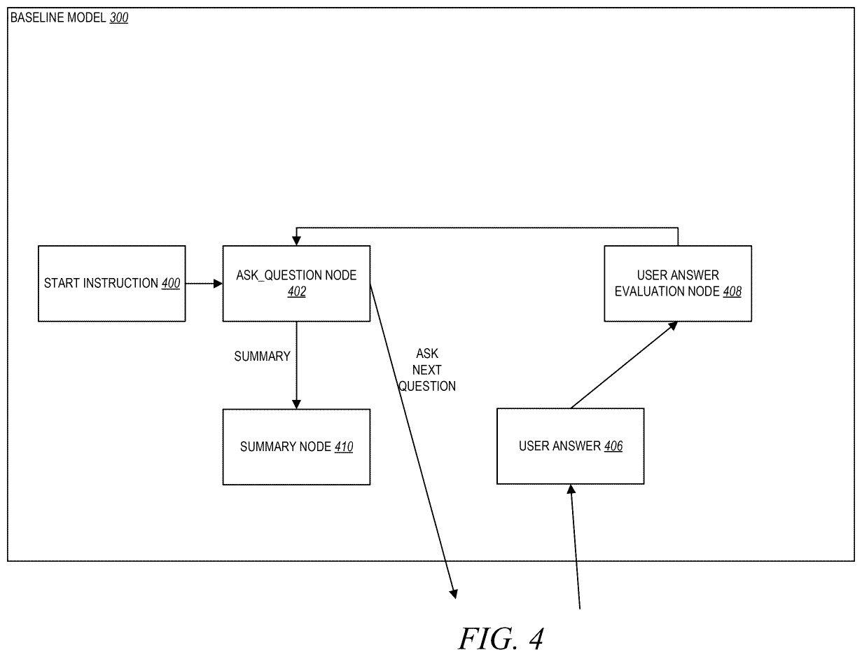

FIG. 4 is a block diagram illustrating execution of a baseline model 300, in more detail. This model poses one question at a time. These questions may include, for example:
1. What is the main goal of this organization process?
2. What are the key steps in the process, and in what order are they carried out?
3. Who is responsible for executing each step?
4. Are there any approvals or decisions required during the process?
5. Is there anything else important that should be considered in this process?

A start instruction 400 triggers the ask_question node 402 to ask the next question, which prompts a user answer 406. A user response evaluation node 408 then evaluates the user answer 406 to determine whether it reflects the interviewer's intention, e.g., whether the question has fulfilled its purposes. It should be noted that this evaluation does not influence the interview's course or the follow-up questions. This evaluation only plays a role in the final evaluation.

After this evaluation is complete, the ask_question node 402 then asks another next question, and the cycle repeats until all the questions have been answered and the answers evaluated. Then the interview transitions to the conditional edge labeled “summary” to a summary node 410, which then uses an LLM to summarize the interview and create a process description. Since this process of summarizing the interview and creating a process description is the same for all the interview agents, it will be described in more detail below after the functionality of each interview agent is discussed.

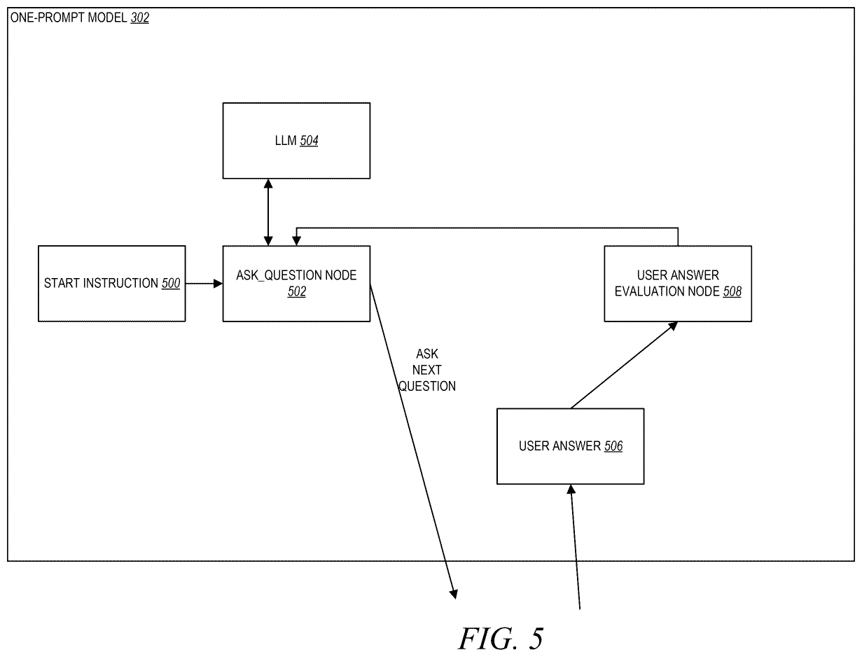

Referring back to FIG. 3, the one-prompt model 302 is a single LLM that conducts the interview and summarizes the process. Here, the single LLM independently decides when the interview is complete and provides a summary. FIG. 5 is a block diagram illustrating a one-prompt model 302, in accordance with an example embodiment.

A start instruction 500 triggers the ask_question node 502 to prompt an LLM 504 for a next question. The ask_question node 502 then asks the question, which prompts a user answer 506. A user response evaluation node 508 then evaluates the user answer 506 to determine whether it reflects the interviewer's intention, e.g., whether the question has fulfilled its purposes. It should be noted just like in the baseline model 300, the result of this evaluation does not influence the interview's course and/or follow-up questions. In some cases, the LLM 504 may be used as part of this evaluation (e.g., asking the LLM 504 whether the user answer 506 satisfies the question).

Once the LMM has decided to stop the interview, the LLM 504 is then prompted for a summary of the interview and to create a process description.

Referring back to FIG. 3, the modularized model 304 is a modular multi-agent system with separate LLMs responsible for asking questions, determining whether the interview is complete, and generating a summary. This provides advantages with respect to maintenance, troubleshooting, and future extensions. More specifically, by separating the determinations of what the next question should be, whether the interview is over, and how to summarize the interview into separate LLM nodes, the performance of the entire system is likely increased.

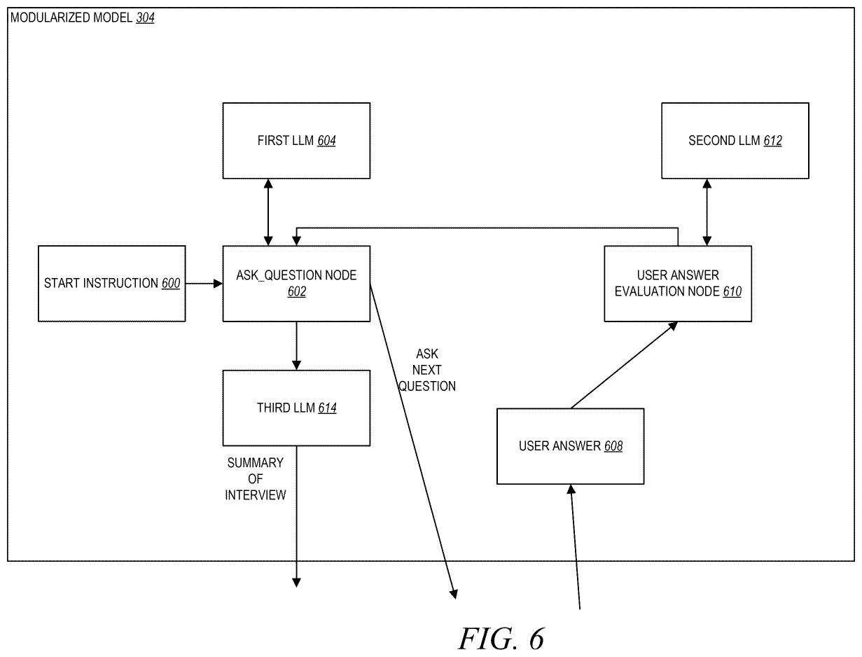

FIG. 6 is a block diagram illustrating a modularized model 304, in accordance with an example embodiment.

A start instruction 600 triggers the ask_question node 602 to prompt a first LLM 604 for a next question. The ask_question node 602 then asks the question, which prompts a user answer 608. A user response evaluation node 610 then evaluates the user answer 608 to determine whether it reflects the interviewer's intention, e.g., whether the question has fulfilled its purposes. Here, a second LLM 612 may aid with this evaluation process.

Once the first LLM has determined that the interview is over, a third LLM 614 is then prompted for a summary of the interview and to create a process description.

Referring back to FIG. 3, the resolver model 306 is a modular approach that includes dedicated handling of incomplete answers. A specific LLM determines the strategy to resolve open or partially answered questions. The resolver model 306 is based on and extends the architecture of the modularized model 304. The iteration of the resolver model 306 prioritizes the resolution of misunderstandings that may emerge during the interview process.

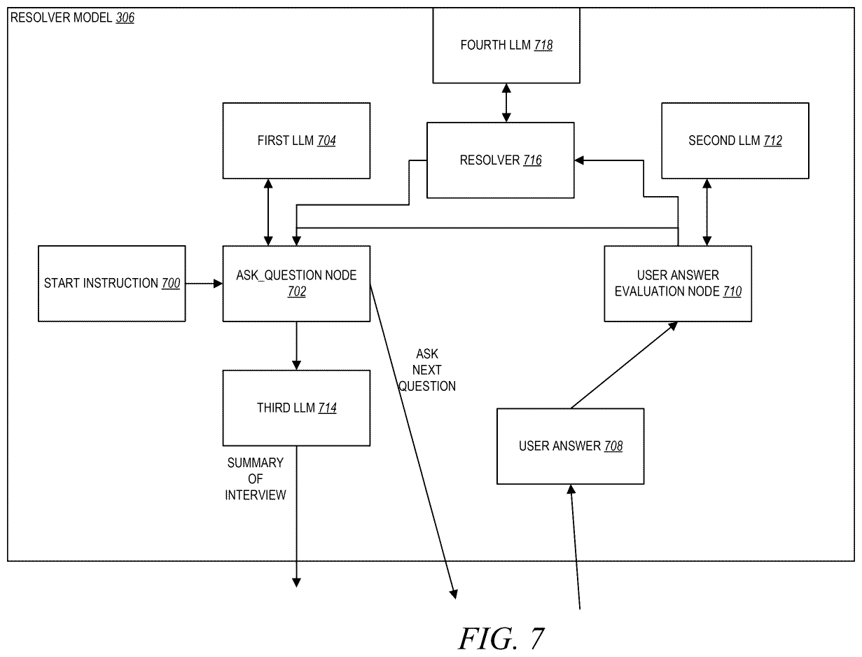

FIG. 7 is a block diagram illustrating a resolver model 306, in accordance with an example embodiment.

A start instruction 700 triggers the ask_question node 702 to prompt a first LLM 704 for a next question. The ask_question node 702 then asks the question, which prompts a user answer 708. A user response evaluation node 710 then evaluates the user answer 708 to determine whether it reflects the interviewer's intention, e.g., whether the question has fulfilled its purposes. Here, a second LLM 712 may aid with this evaluation process. Only once the evaluation indicates that the user answer 708 has fulfilled the question's purposes does the LLM 704 then get prompted for a next question.

Once the first LLM has determined that the interview is over, a third LLM 714 is then prompted for a summary of the interview and to create a process description.

In the event that the answers do not align with the UI agent's 712 expectations, a resolver 716 is invoked. The resolver 716 employs a fourth LLM 718 to analyze the questions and answers and determine the most suitable strategy for rectifying the situation. These strategies could include, for example, requesting that the user rephrase their answer or provide an example or, in instances where the fourth LLM 718 identifies the question as generally unsuitable, the suggestion of a new question.

The fourth LLM 718 is also able to see all the questions and answers, including those generated after the resolver 716 was first called. This ensures that, for instance, if the fourth LLM 718 suggests a particular strategy and this strategy is unsuccessful, then the fourth LLM 718 will then suggest a different strategy. In some example embodiments, a maximum number of iterations may be enforced to prevent the resolver 714 from becoming stuck in an infinite loop.

Referring back to FIG. 3, the summaries model 308 is a modular approach that presents a preliminary summary to the user before ending the interview. The final summary is generated only after user confirmation. Like the resolver model 308, the summaries model 308 is also based on the modularized model 304 and extends the architecture of the modularized model 304. The summaries model 308 deals with the question of the stopping criterion. This refers to the point in the interview at which the interview should end.

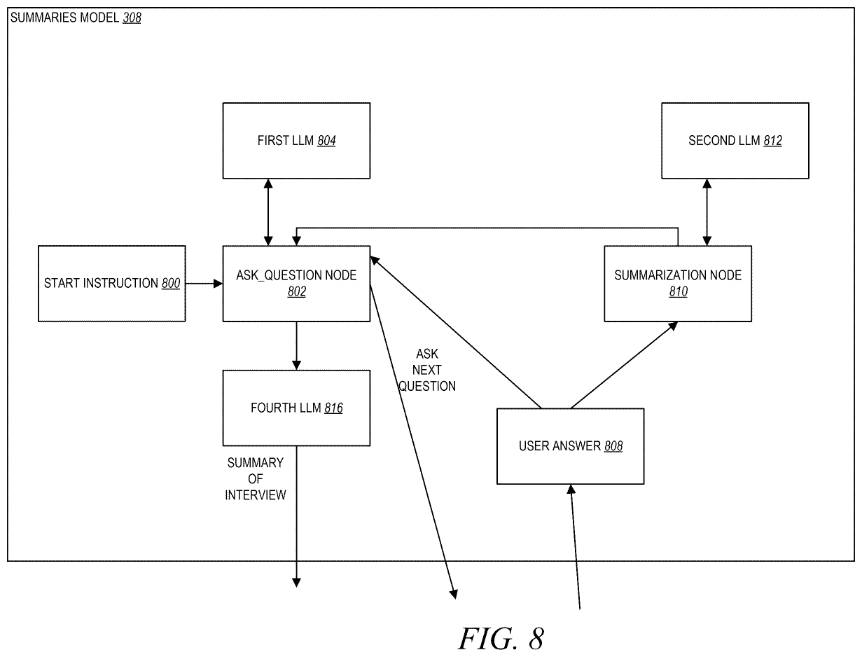

FIG. 8 is a block diagram illustrating a summaries model 308, in accordance with an example embodiment. A start instruction 800 triggers the ask_question node 802 to prompt a first LLM 804 for a next question. The ask_question node 802 then asks the question, which prompts a user answer 808. Here, instead of a user response evaluation node, a summarization node 810 summarizes the interview so far using a second LLM 812 and prompts a user to answer whether the interview can end. If the user indicates the interview cannot end, then the interview continues. If the user indicates that the interview can end, then a fourth LLM 816 is then prompted for a summary of the interview and to create a process description.

Referring back to FIG. 3, the reasoning model 310 is a modular approach with a reasoning node that regularly analyzes the course of the interview and suggests suitable follow-up questions to the questioning LLM.

In the preceding models based on the modularized model 304, the questions are generated by an LLM in the node ask_question. Here, however, a reasoning LLM is introduced with the objective of enhancing the quality of the questions posed. This reasoning model generates recommendations for the LLM in ask_question based on the previous course of the interview. The LLM is then instructed to focus the next questions on these recommendations. These recommendations are incorporated into the LLM's prompt, ensuring that while the formulation of the questions is still left to the LLM, the topics are predetermined by the reasoning model.

Given the expense and time consumption of invoking a reasoning model, in some example embodiments the node check_if_time_to_reason is only activated after the initial question and then after some number of additional questions (e.g., only after every three questions). This approach is designed to strike a balance between the frequency of model calls and the duration of the interview.

It is also possible to invoke the reasoning model in parallel to the interview. For example, after the first question the reasoning model can be invoked, but then the agent continues with the interview without waiting for a response from the reasoning model. As soon as the response is available, the ask_question LLM is taking the response into account. It could take it into account on the next questions, or sometime also later.

A recommendation derived from the reasoning model could be to focus more on the consequences of a rejected application in the next question, or to ask a detailed question about a process step that has not been sufficiently explored.

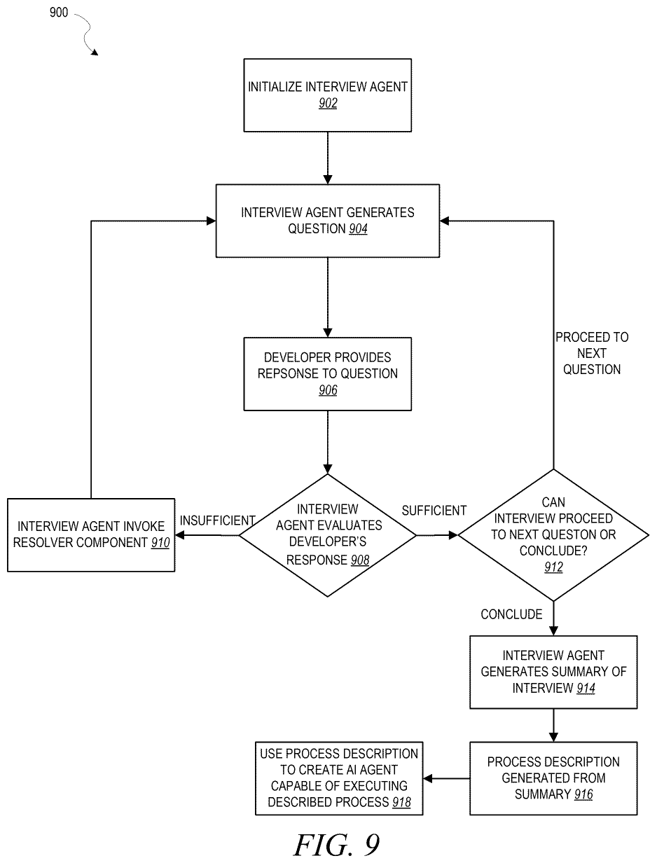

FIG. 9 is a flowchart illustrating a method 900, according to some examples, of conducting an automated interview to extract process knowledge and generate a process description. Although the example method depicted in FIG. 9 illustrates a particular sequence of operations, the sequence may be altered without departing from the scope of the present disclosure. For example, some of the operations depicted may be performed in parallel or in a different sequence that does not materially affect the function of the method. In some examples, different components of an example device or system that implements the method may perform functions at substantially the same time or in a specific sequence.

At operation 902, the method begins by initializing the interview agent. The initialization may involve loading a system prompt into the large language model (LLM) that defines the agent's role, task, and expected behavior during the interview. In some examples, the system prompt may include instructions for conducting a structured or semi-structured interview, specifying the types of questions to be asked and the format of the responses. The initialization may also involve setting up memory components, such as short-term memory represented by the LLM's context window and long-term memory implemented using vector-based retrieval. The memory components may store process descriptions, user responses, and intermediate summaries generated during the interview. Additionally, existing process models or existing process descriptions can also be included here so that the interview AI agent could take it into account.

At operation 904, the interview agent generates an initial question. The question may be generated by an LLM based on the system prompt and any available context, such as prior interactions or predefined interview protocols. In some examples, the initial question may be a broad, open-ended query designed to elicit an overview of the process, such as “What is the main goal of this process?” The question generation may involve reasoning models that analyze the context and suggest areas for deeper inquiry. The generated question is transmitted to the developer.

At operation 906, the developer provides a response to the question. The response may be received as text input and processed by the interview agent. In some examples, the response may include detailed descriptions of process steps, decision criteria, and dependencies. The response is stored in the short-term memory of the interview agent and may also be added to the long-term memory for future retrieval.

It should also be noted that in some example embodiments, the interviews may be conducted via audio communications, through the use of automatic speech recognition (ASR) interfaces. In that way, for example, the interviews may be conducted between the developer and the interview UI agent over a phone or using a microphone of a computing device.

At operation 908, the interview agent evaluates the developer's response. The evaluation may involve analyzing the response to determine whether it sufficiently addresses the question posed. In some examples, the evaluation may be performed by an LLM using predefined criteria, such as completeness, relevance, and clarity. If the response is deemed insufficient, the agent may invoke a resolver component at operation 910. The resolver component may employ strategies such as rephrasing the question, requesting an example, or generating a follow-up question to clarify the user's response. The resolver may iterate through these strategies until the response is deemed sufficient or a maximum number of iterations is reached.

At operation 912, the interview agent determines whether the interview can proceed to the next question or conclude. This determination may be based on the sufficiency of the responses received and the completeness of the extracted process knowledge. In some examples, the agent may use a reasoning model to analyze the trajectory of the interview and decide whether additional questions are needed. If the interview is deemed complete, the method proceeds to operation 914. Otherwise, the agent generates the next question at operation 904, and the process repeats.

At operation 914, the interview agent generates a summary of the interview. The summary may be created by an LLM using the responses stored in the short-term and long-term memory. The summary may include a detailed description of the process steps, decision criteria, and dependencies extracted during the interview. In some examples, the summary may be presented to the user for validation, allowing the user to confirm its accuracy or provide additional input. The validated summary is stored as the final output of the interview.

At operation 916, a process description is generated from the summary.

At operation 918, the process description generated from the summary is used to create an AI agent capable of executing the described process. The agent may interact with external systems, such as databases, APIs, or software tools, to perform tasks based on the process description. In some examples, the process description may be formatted as a Business Process Model and Notation (BPMN) file or other structured data format to facilitate integration with existing systems.

In some examples, the operations described in FIG. 9 may be performed in parallel or in a different sequence. For instance, the evaluation of user responses at operation 908 may occur concurrently with the generation of the next question at operation 904. Similarly, the generation of the summary at operation 914 may be performed incrementally during the interview, rather than as a final step. These variations do not materially affect the function of the method and fall within the scope of the present disclosure.

One technical issue that arises with the implementation of the interview AI agent is that it is challenging to be able to perform a consistent and objective evaluation of the efficacy of the interview AI agent. Some of this is due to the fact that different process developers could place different importance on different aspects of an interview. For example, one developer may place significant emphasis on the precise naming of steps for the end result while another may be more concerned with the correct representation of iterations in the process. Some of the challenge, however, is inherent to the nature of LLM, which serves as the foundation of the interview agent, and which have non-deterministic responses. Thus, otherwise identical conditions (e.g., an identical response to the same question) results in different responses.

Consequently, the evaluation of the interview agent, particularly in scenarios with limited test cases, can yield unreliable outcomes. To avoid this and to take into account the non-determinism of LLMs in the evaluation, the evaluation of the interview agents is not done by selected process experts, but by a simulated process participant know as human proxy agent (HPA), which are generated by an LLM based on process descriptions. These process descriptions, also referred to as scenarios or test data, are employed for two primary purposes: first, to extract fictitious personas from the descriptions, and second, to ground these personas in the process knowledge. A persona is defined as a hypothetical user representing a group of similar users. In essence, these HPAs respond in a manner consistent with a real person who has knowledge of the process.

The structure of the HPA, which behaves like a human by contextualization through process descriptions, is crucial for the success of the evaluation. Agents must first be grounded in a role or persona, which can be achieved through prompt engineering or fine-tuning (profiling). In addition, agents should be able to access knowledge and experiences (memory) and adapt their current behavior to this knowledge (reflection). Furthermore, agents should be capable of planning multiple action steps to imitate human workflows (planning).

Since the HPA only has to respond to one interview question and does not perform any further actions, this evaluation does not include the implementation of separate planning and action components. The output of the HPA is always in textual form.

The initialization of the HPA is executed once for each test data set and then reused for each interview agent. The initialization process involves the extraction of interview personas from the process description and the generation of grounding data for each of these interview personas. These include a concise process synopsis from the persona's viewpoint, two experiences/memories with the process that the persona has encountered, and a comprehensive description of the process from the persona's perspective. In this context, it is imperative that the LLM hallucinates these experiences and descriptions, i.e., that they are not based on data that the LLM can access. The specific experiences generated by the LLM are ultimately inconsequential, as they vary significantly.

It should be noted that the term “hallucinate” shall be interpreted to mean generating an output that is not based on data that the LLM can access. Some in the artificial intelligence world may define “hallucinate” more narrowly to mean false, nonsensical, or fabricated, those definitions are not reflective of the scope of the present disclosure. There are circumstances where the definitions overlap. From the perspective of the LLM, data that is generated that is not based on data the LLM can access is subjectively fabricated (and possibly even false, from that perspective), but it is important to differentiate this from being objectively false or fabricated.

Referring back to FIG. 1, an HPA management component 127 manages one or more HPAs, such as HPA 128, which are used to test the interview AI agent 120. Each HPA 128 may contain a number of different personas. Each persona may be created by a profiling component 129. The process begins with identifying relevant roles associated with the process being simulated. This involves analyzing the process description to determine the individuals or entities involved. For example, in a vacation request process, the roles might include an employee, a supervisor, and an HR representative. An LLM 132 is prompted to extract these roles from the process description, producing a structured list of personas that forms the basis for generating individual profiles.

Once the personas are identified, the LLM 132 generates detailed profiles for each role. This includes creating a narrative that captures the persona's perspective, responsibilities, and experiences with the process. The LLM provides a comprehensive description of the process from the persona's viewpoint, detailing their involvement and interactions with other roles. For example, the employee's perspective might focus on submitting the vacation request, while the supervisor's perspective might emphasize the criteria for approval or rejection. The LLM also generates plausible examples of the persona's past experiences with the process, ensuring that these examples are consistent with the process description and provide realistic scenarios. For instance, the supervisor might describe a situation where a vacation request was rejected due to insufficient staffing. These examples are integrated into the persona's profile to enhance realism and contextual accuracy.

The profiling component 129 combines the detailed process description and hallucinated experiences to create a concise grounding for each persona. This grounding encapsulates the persona's role and perspective in a few sentences, providing a clear summary of their involvement in the process. For example, the grounding for the employee might state, “You are an employee who submits vacation requests and reviews feedback from your supervisor.” This grounding ensures that the persona's responses during interactions align with their role and the process description.

Each HPA can also have a different personality, such as different response behavior like response length, tone, proficiency, etc. In this way, the personas are even more variable.

The planning component 130 may be used to break tasks into smaller tasks, as described earlier.

To enhance the realism of the personas, the generated profiles and experiences are stored in the long-term memory of a memory component 134. Short-term memory of the memory component 134, represented by the LLM's context window, stores the ongoing conversation, allowing the persona to provide responses that are contextually relevant to the current interaction. The combination of long-term and short-term memory enables the HPA 128 to emulate human-like recall and decision-making.

The profiling process assigns each persona a specific role, which the HPA 128 embodies during interactions with the interview AI agent 120. This is achieved through prompt engineering, where the system prompt includes instructions for the persona's behavior, tone, and perspective. For example, the prompt for the supervisor might instruct the LLM to respond with authority and focus on decision-making criteria. Few-shot learning may be used to enhance the persona's responses, with the prompt including examples of the persona's behavior, such as sample questions and answers, to guide the LLM's output. This ensures that the persona's responses align with their role and the process description.

The generated personas are integrated into the HPA 128, where they are used during interactions with the interview AI agent 120.

In an example embodiment each persona is instantiated as a separate node in a LangGraph workflow, allowing for parallel execution of tasks.

LangGraph is an open-source framework designed to orchestrate multi-agent systems (MAS) using graph-based structures. It provides a way to model workflows where multiple agents collaborate to perform tasks using LLMS for natural language processing and decision-making. In LangGraph, workflows are represented as directed graphs, with nodes corresponding to specific functions or tasks performed by agents and edges defining the flow of information or decision-making between nodes.

The framework uses a shared state, implemented as a TypedDict, to store and manage data that agents can access and modify during execution. This shared state acts as a common knowledge base for the entire graph, allowing agents to interact and share information seamlessly. LangGraph supports modularity by enabling individual nodes to represent distinct functions, such as generating questions, evaluating responses, or summarizing data. This modular design allows for easy replacement or modification of components without affecting the overall system.

LangGraph facilitates dynamic decision-making and iterative processes through conditional edges and loops. It also supports parallel execution of tasks, improving efficiency in workflows involving multiple agents. The framework integrates with LLMs, enabling agents to perform tasks such as reasoning, summarization, and validation. It allows for the use of multiple LLMs, each specialized for specific tasks, and can dynamically generate multiple instances of a node based on the value of a state variable. This feature is particularly useful for creating multiple agents or personas to handle different aspects of a task simultaneously.

In the present case, the shared state stores the persona's profile, grounding, and memory, ensuring that the responses are consistent and contextually accurate.

The profiling steps are implemented in two functions of a LangGraph, which are represented as nodes. LangGraph is useful because in the present case the number of identifiable personas varies from use case to use case, so a different number of personas can be involved in each process. A key feature of LangGraph is its capacity to generate instances of another node based on the value of a state variable. This worker principle enables the generation of any number of identified personas from the function (identify_personas) for each persona in isolation, where the grounding is established.

The identify_personas function utilizes an LLM 132 to identify all involved personas and returns them as a list. The structured output function of the LLM is employed in this instance, whereby the model output is organized in such a way that it can be read as regular Python data types (such as list or dict). Below is an example of an assign workers function to generate personas and grounding simultaneously.

| 1 | def assign_workers(state: State) −> List[Command]: |
|---|---|
| 2 | return [Send(“generate_persona”, |
| 3 | {“persona”: persona, “processBPM”: |
| state[“processBPM”]}) | |
| 4 | for persona in state[“personas”]] |

The function generate_persona is now invoked for each persona. This is achieved by means of the assign_workers function. This function initiates an instance of the generate_persona node for each persona and passes the persona's name and the general process description to it.

The generate_persona function then executes three LLM calls sequentially, building upon each preceding call. In the initial call, the model is prompted to hallucinate the process based on the process description from the persona's viewpoint, as detailed as possible. In the subsequent call, the model is tasked with generating two example experiences of the persona with the process, leveraging the description from the previous call. The cascading nature of these calls ensures that the hallucinated information does not contradict itself. The third call integrates the comprehensive process description with the two examples, yielding a concise introduction of the persona (grounding) in two to three sentences. While the process description and the examples later become part of the long-term memory of the agent, this introduction is used as profiling of the human proxy agent by means of prompt engineering.

The following is an example of a profiling state that is returned by the generate_persona function.

| | |
|---|---|
| 1 | class State(TypedDict): |
| 2 | processBPM: str |
| 3 | numberPersonas: int |
| 4 | personas: List[str] |
| 5 | personasDescription: Annotated[list, operator.add] |
| 6 | personasExamples: Annotated[list, operator.add] |
| 7 | personasProfile: Annotated[list, operator.add] |
| 8 | personasGrounding: Annotated[list, operator.add] |

The generated state is then saved and used later to initialize the user proxy agent.

The following is an example of a graph node for HPA.

| | |
|---|---|
| 1 | def human_proxy_agent(state: State) −> dict: |

2

| | |
|---|---|
| 3 | context = get_chunks(state[“interview_context”][−1].content, |

vector_store)
4

| | |
|---|---|
| 5 | msg = invoke_and_retry( lambda: human_llm.invoke( |
| 6 | [ |
| 7 | SystemMessage(load_prompt(“interview/hpa”, profile = |

str(short_term_knowledge[“profile”]), grounding = str

| | |
|---|---|
| 8 | ] |

9

| | |
|---|---|
| 10 | + [HumanMessage(msg.content) if isinstance(msg, AIMessage) else |

AIMessage(msg.content) for msg in state[“inter
11

| | |
|---|---|
| 12 | + [HumanMessage(“Answer based on this context: \n” + |

“\n”.join([document.page_content for document in context]

| | |
|---|---|
| 13 | )) |

14

| | |
|---|---|
| 15 | return { |
| 16 | “interview_context”: state[“interview_context”] + |

[HumanMessage(msg.content)]

| | |
|---|---|
| 17 | } |

In an example embodiment, the HPA 128 is integrated into the graphs of the AI interview agent 120 to be compared as a separate node. This configuration offers the benefit of enabling the humanoid agent to access the state of the interview, thereby enabling it to follow the course of the conversation.

Each time the HPA is invoked, a new context is first retrieved from the agent's long-term memory. This implementation signifies the integration of the memory component 134, a feature considered essential for humanoid agents. The long-term memory consists of on the one hand of the detailed process description of the persona and on the other hand of the two process experiences that the persona can remember. The transformation of both contexts into vectors may be performed by an embedding model. In contrast to the outputs of an LLM, the vector store created through this process is deterministic, ensuring that the same text always results in the same vectors.

In an example embodiment, in order to mitigate the complexity of vectorizing descriptions of personas multiple times, a caching principle is employed. The memory is populated with a chunk size of, for example, n=250, with an overlap of m=50 characters. In the event that the HPA is queried, the principle of RAG is employed to retrieve the most similar k chunks.

The call to the LLM 132 is augmented by adding the chunks to the current prompt before each generation and asking the LLM 132 to use this context for the response. Conversely, the previous course of the conversation, which is stored in the state variable in interview_context, is added to the context window. It should be noted that the interview context is from the interviewer's perspective. Consequently, a message of the class AIMessage originates from the interviewer, while a message of the class HumanMessage originates from the interviewee. However, to enable the messages of the HPA to be generated, i.e., to see the answers of the HPA as AIMessage and those of the agent as HumanMessage, the List Comprehension swaps the two message types here. The interviewer's messages are therefore treated as HumanMessages in the HPA, to which the system responds as an AIMessage. As a system prompt, both the name of the persona and the short grounding previously discussed are loaded into the context window as a form of short-term memory. This prompt engineering approach, ensures that all responses in this persona are contextualized.

Finally, the content of the last message of the HPA 128, i.e., the response to the invoked LLM, is added to the current interview context. Given that the context is designed from the interviewer's point of view, as previously mentioned, the content is appended as an instance of the HumanMessage class.

Once the interview AI agent has been tested using the HPA, its performance may be evaluated. This may include various types of metrics, including speed, how consistent was the output, how long were the messages, and was the goal reached. In some example embodiments, an LLM may be used to evaluate the performance of the interview AI agent by, for example, rating the discussion between the interview AI agent and the HPA.

It should be noted that while the above discussion describes embodiments where the HPAs are used to test an interview AI agent, in some example embodiments the HPAs can be used to test any AI agent (basically any non-HPA AI agent), and thus the present disclosure is not just limited to using HPAs to test interview AI agents.

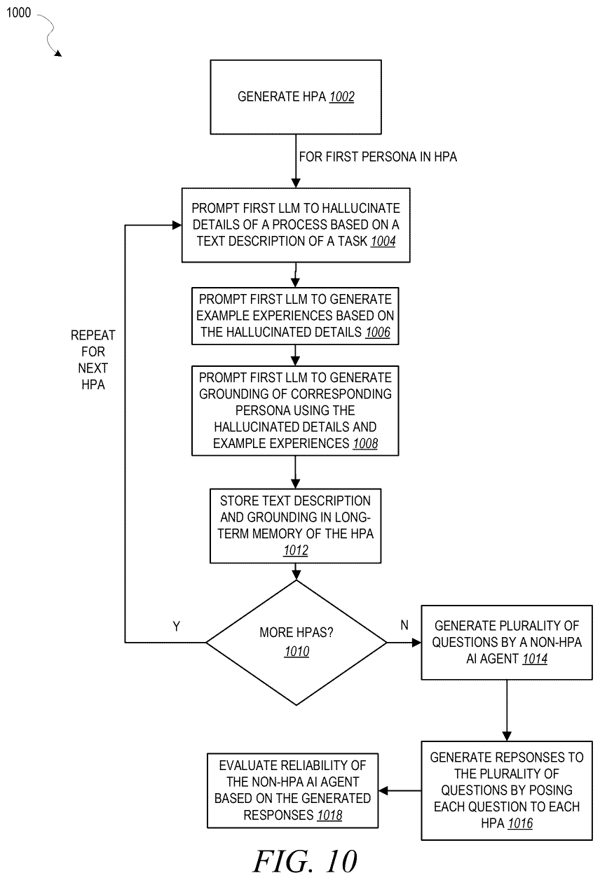

FIG. 10 is a flow diagram illustrating a method 1000 for generating and using an HPA, in accordance with an example embodiment. Although the example method depicted in FIG. 10 illustrates a particular sequence of operations, the sequence may be altered without departing from the scope of the present disclosure. For example, some of the operations depicted may be performed in parallel or in a different sequence that does not materially affect the function of the method. In some examples, different components of an example device or system that implements the method may perform functions at substantially the same time or in a specific sequence.

At operation 1002, one or more human proxy agents (HPAs) are generated by using a first LLM to generate a plurality of personas based on a text description of a task to solve, each HPA being an artificial intelligence (AI) agent corresponding to a different persona. A series of operations are then performed for each HPA. At operation 1004, the first LLM is prompted to hallucinate details of a process based on a text description of a task. At operation 1006, the first LLM is prompted to generate example experiences of interactions between a corresponding persona and the task, based on the hallucinated details. At operation 1008, the first LLM is prompted to generate a grounding of a corresponding persona using the hallucinated details and the example experiences.

At operation 1010, the text description and the grounding are stored in long-term memory of the HPA.

At operation 1012, it is determined if this is the last HPA. If not, then the method 1000 loops back to operation 1004 for the HPA. If so, then at operation 1014, a plurality of questions are generated by an a non-HPA AI agent. At operation 1016, responses to the plurality of questions are generated by posing each of the plurality of questions to each HPA. At operation 1018, reliability of the non-HPA AI agent is evaluated based on the generated responses.

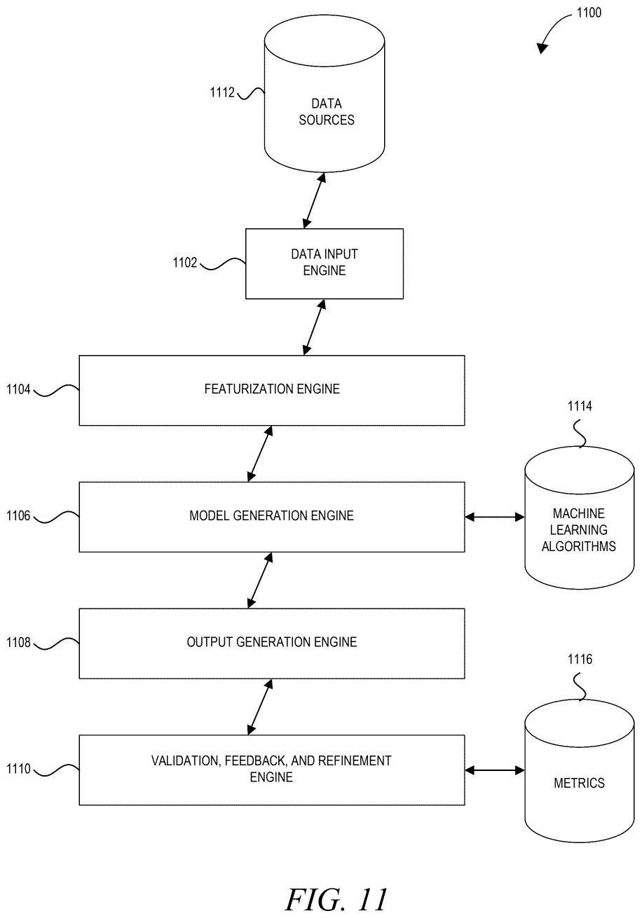

As mentioned earlier, the embedding machine learning model may be a model selected from one of any number of different types of machine learning models. FIG. 11 illustrates a machine learning system 1100, according to some examples. The machine learning system 1100 may be used to implement aspects of the present disclosure. The machine learning system 1100 is shown to include a data input engine 1102, a featurization engine 1104, a model generation engine 1106, an output generation engine 1108, and a validation, feedback, and refinement engine 1110.

The data input engine 1102 may be configured to access, interpret, request, format, re-format, or receive input data from data sources 1112. Data sources 1112 may include training data (e.g., data for training machine learning models), validation data (e.g., data for comparing model output with known results to evaluate performance), or reference data (e.g., data used to establish baselines or inform model creation). The data input engine 1102 can interact with external data systems via input/output (I/O) devices, network interfaces, or storage elements to ensure input data is processed and stored in a suitable format for further operations.

The featurization engine 1104 may be configured to transform input data into features that are optimized or useful for machine learning. The featurization engine 1104 can handle feature extraction, scaling, or selection, enabling the machine learning system 1100 to identify and process relevant data attributes for subsequent modeling. For example, features extracted from raw data may be annotated, labeled, or transformed into numerical representations suitable for machine learning algorithms 1114. The featurization engine 1104 can work iteratively with other components to refine features based on model requirements or outcomes.

The model generation engine 1106 is responsible for creating, training, and configuring one or more machine learning models based on input data and selected features. The model generation engine 1106 may include functionality for model selection, hyperparameter tuning, or algorithm implementation.

Machine learning broadly involves using computer algorithms to automatically learn patterns and/or relationships in data, often without the need for explicit programming. Thus, the machine learning algorithms 1114 may include various algorithms:
Supervised
   Classification
      Naive Bayes
      Logistic Regression
      K-Nearest Neighbor (KNN)
      Random Forest
      Support Vector Machine (SVM)
      Decision Tree
   Regression
      Random Forest
      Support Vector Machine (SVM)
      Decision Tree
      Simple Linear Regression
      Multivariate Regression
      Lasso Regression
Unsupervised
   Clustering
      K-Means Clustering
      DBSCAN Algorithm
      Principal Component Analysis
      Independent Component Analysis
   Association
      Frequent Pattern growth
      A-priori Algorithm
      Anomaly Detection
      Z-score Algorithm
      Isolation Forest Algorithm
Semi-Supervised
   Classification
      Self-Training
      Co-Training
   Regression
      Self-Training
      Co-Training
Reinforcement
   Model-Free
      Policy Optimization
      Q-Learning
      Model-Based
   Learn the Model
      Given the Model

The model generation engine 1106 may also support iterative model refinement and validation cycles, enabling adaptability to evolving data or performance criteria.

In some examples, the output generation engine 1108 is responsible for model inference. The output generation engine 1108 processes data to produce predictions, classifications, or other results. The output generation engine 1108 can also apply post-processing techniques such as aggregation, thresholding, or confidence scoring to ensure outputs are in a format suitable for downstream systems or user interpretation.

The validation, feedback, and refinement engine 1110 may be configured to validate, monitor, or improve the performance and relevance of machine learning models over time. The validation, feedback, and refinement engine 1110 can apply validation data to assess model outputs and integrates feedback from users or automated systems to improve models. Metrics 1116 may be used to evaluate and compare model outputs against validation data or other useful data, providing insights into model performance, accuracy, reliability, or generalization. Refinement operations may involve retraining models with updated data or adjusting model parameters to account for changing conditions or newly observed patterns.

Components of the machine learning system 1100 may be implemented by hardware processors and may communicate via network interfaces or shared storage elements to facilitate data exchange and coordination. The architecture shown in FIG. 11 allows for flexible deployment across various machine learning applications, such as natural language processing, computer vision, or predictive analytics.

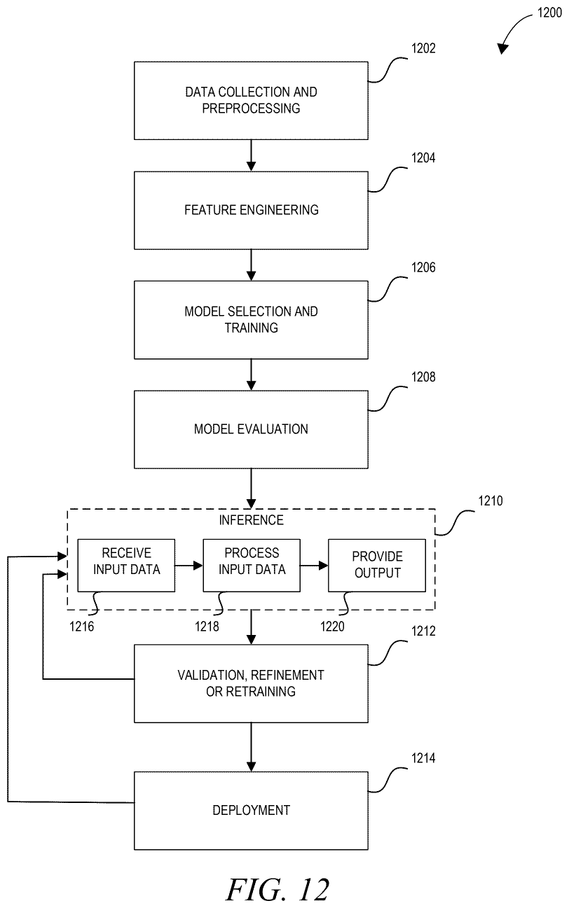

FIG. 12 is a flowchart depicting a machine learning pipeline 1200, according to some examples. The machine learning pipeline 1200, or parts thereof, may be used to generate a trained machine learning model for use in examples of the present disclosure. In some examples, a system such as the machine learning system 1100 of FIG. 11 is used to implement the machine learning pipeline 1200.

The machine learning pipeline 1200 commences with a data collection and preprocessing stage 1202, in which data is acquired, cleaned, or formatted for compatibility with machine learning algorithms. The data collection and preprocessing stage 1202 may also involve addressing issues such as duplicate entries, missing values, or data inconsistencies.

During a feature engineering stage 1204, training data can be formatted, transformed, or selected as needed to create features that are useful for predicting target data. Feature engineering may include (1) receiving features (e.g., as structured or labeled data in supervised learning) and/or (2) identifying features (e.g., unstructured or unlabeled data for unsupervised learning) in training data. In this context, a feature may be variable or attribute, such as a measurable property of a process, article, system, or phenomenon represented by a data set. Features may also be of different types, such as numeric features, strings, and graphs, and may include one or more of content, concepts, attributes, historical data, or user data, merely for example.

A model selection and training stage 1206 can include selecting an appropriate machine learning algorithm or strategy and training the relevant model on training data. The model selection and training stage 1206 may involve splitting the data into training and testing sets, using cross-validation to evaluate the model, and tuning hyperparameters to improve performance. During training, the model may be trained to find features that affect a predicted outcome. The result of the training is a trained machine learning model.

In some examples, techniques such as model quantization, pruning, or knowledge distillation can reduce the computational complexity of a trained model. Quantization involves reducing the precision of weights and activations (e.g., from Z2-bit floating-point to 8-bit integers), enabling efficient deployment on hardware-constrained environments such edge devices. Pruning removes redundant or non-contributory connections within a model, thereby reducing memory and processing requirements. Knowledge distillation transfers the learned knowledge of a large, complex model into a smaller, lightweight model.

A model evaluation stage 1208 may include evaluating the performance of a trained model on a separate testing dataset. This can help determine if the model is overfitting or underfitting and determine whether the model is suitable for deployment. Regularization techniques, such as dropout or L2 regularization, may also be employed to prevent overfitting and improve generalization.

FIG. 12 further shows an inference stage 1210, in which a trained model generates outputs on new, unseen data. For example, for each input, at operation 1216, the model receives input data (e.g., from external sources, such as real-time sensors, databases, or user-provided queries, or internal sources such as test inputs). At operation 1218, the trained model processes the input data. This can include various operations that are performed to arrive at output data, such as feature extraction, transformation, and embedding generation, depending on the model architecture. For example, a CNN may process input images by applying convolutional filters, while a transformer model might encode textual input using self-attention mechanisms. The trained model may perform inference, mapping inputs to outputs, such as predictions or classifications, thereby providing the output data at operation 1220.

It is noted that output data may take various forms. In classification AI examples, outputs may include data classifications or probabilities linked to particular classifications. In generative AI examples, outputs may include new content, such as translations, summaries, answers, new media content, or combinations thereof. In some examples, outputs are further processed into usable output, such as probabilities, labels, or continuous values tailored for downstream systems. Post-processing may include confidence scoring, aggregation, or error correction, to ensure outputs are accurate and actionable for the intended application.

The machine learning pipeline 1200 may also include a validation, refinement, or retraining stage 1212. This may include updating a model based on feedback generated from the inference stage 1210, such as new data or user feedback. In some examples, validation is performed as a separate dataset known as the validation dataset. The validation dataset can be used to tune or fine-tune the hyperparameters of a model, such as the learning rate and the regularization parameter. The hyperparameters may be adjusted to improve the model's performance on the validation dataset.

During deployment stage 1214, the trained model is integrated into or connected with a more extensive or real-world system, application, or environment, such as a web service, mobile app, or Internet of Things (IoT) device. This phase can involve setting up APIs, building a user interface, and ensuring that the model is scalable and can handle large volumes of data. In some examples, the trained model is deployed on a single device, such as locally on an end user's computing device or on an edge device, as opposed to being deployed on a server system. This may provide lower latency or offline functionality in certain scenarios. Accordingly, various trained models can be deployed as server-based deployments or on-device deployments.

In some examples, a trained model includes one or more neural networks. The neural network may include a hierarchical (e.g., layered) organization of neurons or nodes, with each layer consisting of multiple neurons or nodes. Neurons in the input layer receive the input data, while neurons in the output layer produce the final output of the network. Between the input and output layers, there may be one or more hidden layers, each consisting of multiple neurons.

Each neuron may operationally compute a function, such as an activation function, which takes as input the weighted sum of the outputs of the neurons in the previous layer, as well as a bias term. The output of this function is then passed as input to the neurons in the next layer. If the output of the activation function exceeds a certain threshold, an output is communicated from that neuron (e.g., transmitting neuron) to a connected neuron (e.g., receiving neuron) in successive layers. The connections between neurons have associated weights, which define the influence of the input from a transmitting neuron to a receiving neuron. During the training phase, these weights are adjusted by the learning algorithm to optimize the performance of the network. Different types of neural networks may use different activation functions and learning algorithms, affecting their performance on different tasks. The layered organization of neurons and the use of activation functions and weights enable neural networks to model complex relationships between inputs and outputs, and to generalize to new inputs that were not seen during training.

A neural network can be applied in various scenarios. In some cases, the neural network is configured to perform an image or video processing task. For example, the task may be image classification. As another example, the task can be image embedding generation and the output generated by the neural network can be a numeric embedding of the input image. As yet another example, the task can be object detection and the output generated by the neural network can identify locations in the input image at which particular types of objects are depicted. As another example, if the input to the neural network is a sequence of text in one language, the output generated by the neural network may be a piece of text in the other language that is a predicted proper translation of the input text into the other language.

In some cases, a machine learning task is a multi-modal processing task that requires processing multi-modal data. In general, multi-modal data is a combination of two or more different types of data, e.g., two or more of audio data, image data, text data, or graph data. As one example, the multi-modal data may comprise audio-visual data, comprising a combination of pixels of an image or of video and audio data representing values of a digitized audio waveform. As another example, the multi-modal data may comprise a combination of text data representing text in a natural language and pixels of an image.

In some examples, the neural network may also be one of several different types of neural networks, such as a single-layer feed-forward network, a Multilayer Perceptron (MLP), an Artificial Neural Network (ANN), a Recurrent Neural Network (RNN), a Long Short-Term Memory Network (LSTM), a Bidirectional Neural Network, a symmetrically connected neural network, a Deep Belief Network (DBN), a CNN, a Generative Adversarial Network (GAN), an Autoencoder Neural Network (AE), a Restricted Boltzmann Machine (RBM), a Hopfield Network, a Self-Organizing Map (SOM), a Radial Basis Function Network (RBFN), a Spiking Neural Network (SNN), a Liquid State Machine (LSM), an Echo State Network (ESN), a Neural Turing Machine (NTM), or a Transformer Network, merely for example.

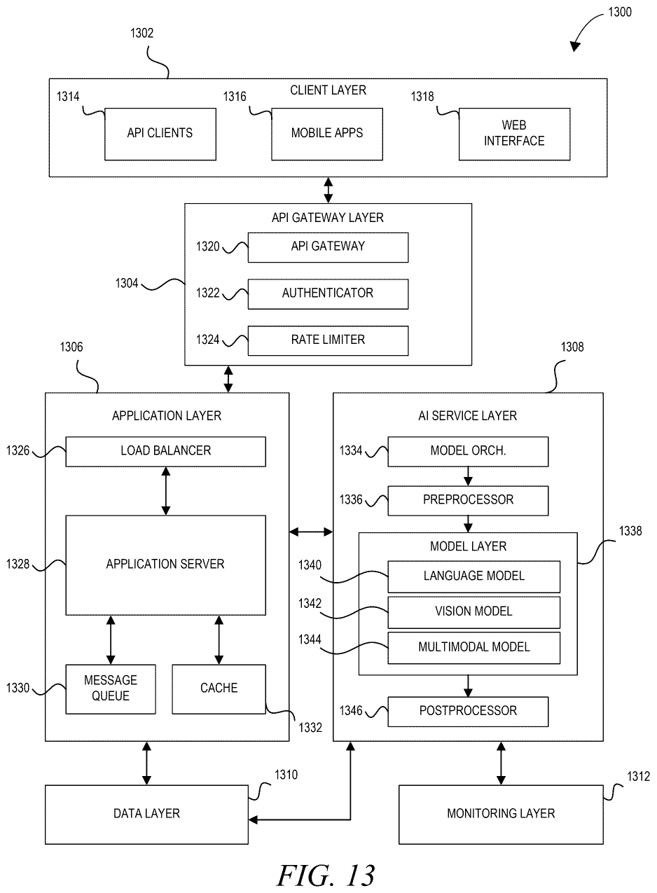

FIG. 13 is a system architecture diagram showing a layered view of an AI integrated system 1300, according to some examples. The AI integrated system 1300 comprises six example layers: a client layer 1302, an API gateway layer 1304, an application layer 1306, an AI service layer 1308, a data layer 1310, and a monitoring layer 1312.

The client layer 1302 provides multiple access points for system interaction. It includes API clients 1314, which may enable programmatic access to the capabilities of the AI integrated system 1300 or integration with third-party systems and services. Mobile applications 1316 facilitate access from mobile applications and devices, for example implementing native mobile protocols while maintaining consistent communication patterns with backend systems. A web interface 1318 enables browser-based access to the capabilities of the AI integrated system 1300 and may communicate with other layers using, for example, Hypertext Transfer Protocol (HTTP) or Hypertext Transfer Protocol Secure (HTTPS) protocols.

The API gateway layer 1304 serves as an entry point for client communications. The API gateway layer 1304 comprises an API gateway 1320, which may implement routing logic to direct incoming requests to appropriate backend services. An authenticator 1322 validates client credentials, for example using industry-standard protocols, such as OAuth 2.0 (Open Authorization 2.0) or JWT (JSON Web Tokens). In some examples, a rate limiter 1324 of the API gateway layer 1304 operates to prevent system abuse or ensure resource allocation among clients.

The application layer 1306 comprises various processing capabilities. In some examples, the application layer 1306 includes a load balancer 1326 that may distribute incoming requests across multiple application server instances to support resource utilization and system reliability. An application server 1328 may implement business or core functional logic of the AI integrated system 1300, processing requests and coordinating responses across various system components. In some examples, a message queue 1330 facilitates asynchronous processing capabilities, enabling efficient handling of operations, and a cache 1332 operates within the application layer 1306 to improve response times for frequently requested data.

The AI service layer 1308 provides AI capabilities through a structured approach to model deployment and execution. In some examples, the AI service layer 1308 includes a model orchestrator 1334 that coordinates the execution of one or various AI models, managing resource allocation and implementing routing logic to direct requests to appropriate model instances. A preprocessor 1336 may prepare input data for model consumption, implementing transformations, validations, or other preprocessing operations.

FIG. 13 shows the AI service layer 1308 as including a model layer 1338. The model layer 1338 may include multiple model types, including, for example, one or more of: a language model 1340 for processing textual input, implementing natural language processing capabilities; a vision model 1342 for handling image or video processing tasks; and a multimodal model 1344 that combines multiple input types to provide comprehensive analysis capabilities. In some examples, a postprocessor 1346 of the AI service layer 1308 transforms model outputs into standardized formats suitable for client consumption. The data layer 1310 provides persistent storage capabilities.

While not detailed in FIG. 13, it is noted that the data layer 1310 may include various components such as a primary database for maintaining transactional data, a vector database for optimizing storage and retrieval of high-dimensional vectors used in AI applications and models of the AI service layer 1308, or a file storage component for managing binary data assets.

The monitoring layer 1312 may provide observability capabilities across the AI integrated system 1300. This may include logging for capturing system events, metrics collection for performance analysis, or distributed tracing for detailed analysis of request flow through the system.

Communication between layers of the AI integrated system 1300 may follow defined patterns. External communications may implement appropriate encryption protocols, for example utilizing Transport Layer Security (TLS) or Secure Sockets Layer (SSL) for data protection. Internal communications may use various protocols selected for specific use cases, for example, Hypertext Transfer Protocol version 2 (HTTP/2), gRPC (Google Remote Procedure Call), or proprietary protocols where appropriate.

Referring again to the model layer 1338, this layer may incorporate various types of machine learning models. Neural networks may be deployed to implement various architectures suited to specific processing needs. These can include, merely for example, fundamental feedforward neural networks for pattern recognition, convolutional neural networks (CNNs, neural networks that may be specialized for processing visual information), recurrent neural networks (RNNs, neural networks that may be designed for sequential data), transformer networks, or other architectures (e.g., Long Short-Term Memory networks (LSTMs) or Gated Recurrent Units (GRUs)).

A language model such as the language model 1340 may use transformer-based architectures (e.g., Bidirectional Encoder Representations from Transformers (BERT), Generative Pre-trained Transformer (GPT) variants, or Text-to-Text Transfer Transformer [T5]) for processing textual data and implementing natural language understanding capabilities. A vision model such as the vision model 1342 may employ specialized neural network architectures (e.g., CNNs, Vision Transformers (ViT), or Residual Neural Network (ResNet) variants) for processing visual information and extracting features from images or video streams. A multimodal model such as the multimodal model 1344 may implement hybrid architectures (e.g., Contrastive Language-Image Pre-training (CLIP), DALL-E variants, or multimodal transformers) designed to process and correlate information across different input modalities, leveraging ensemble approaches to combine multiple model types using model aggregation or weighted prediction strategies. A multimodal model may combine textual, visual, and other forms of input data to provide analysis and generate integrated outputs that leverage cross-modal understanding capabilities.

The AI service layer 1308 may provide both supervised learning models (e.g., decision trees, random forests, or support vector machines) for specific classification and prediction tasks, and unsupervised learning models (e.g., k-means clustering or principal component analysis) for pattern discovery and dimensionality reduction within the data processing pipeline. Probabilistic models (e.g., Bayesian networks or hidden Markov models) may be integrated within the AI service layer 1308 to handle uncertainty in decision-making processes, working in conjunction with the preprocessor 1336 and postprocessor 1346 components to provide probability estimates and confidence metrics for model outputs.

Each model type may be implemented using various deployment strategies, with the model orchestrator 1334 managing their execution and resource allocation to ensure adequate performance and efficient system operation. This may include coordinating the deployment and execution of various model types, ensuring efficient resource allocation, and appropriate model selection based on specific task requirements. While in some examples the model layer 1338 provides server-based access to one or more models, a model can alternatively (or additionally) be deployed so as to perform inference locally (e.g., at the client layer 1302).

In view of the disclosure above, various examples are set forth below. It should be noted that one or more features of an example, taken in isolation or combination, should be considered within the disclosure of this application.

Example 1 is a system comprising: at least one hardware processor; a non-transitory computer-readable medium storing instructions that, when executed by the at least one hardware processor, cause the at least one hardware processor to perform operations comprising: generating a human proxy agent (HPA) by using a first LLM to generate a plurality of personas based on a text description of a task to solve, the HPA being an artificial intelligence (AI) agent; for each persona of the plurality of personas: prompting the first LLM to hallucinate details of a process based on a text description of a task; prompting the first LLM to generate example experiences of interactions between a corresponding persona and the task, based on the hallucinated details; prompting the first LLM to generate a grounding of a corresponding persona using the hallucinated details and the example experiences; storing the text description and the grounding of each of the plurality of personas in long-term memory of the HPA; generating, by an interview artificial intelligence (AI) agent, a plurality of questions regarding attributes of a runtime AI agent; generating responses to the plurality of questions by posing each of the plurality of questions to each persona of the HPA; and evaluating reliability of the interview AI agent based on the generated responses.

In Example 2, the subject matter of Example 1 comprises, wherein the using the first LLM to generate the plurality of personas is performed as a first node of a first LangGraph, and wherein the operations performed for each persona of the plurality of personas are performed as a second node of the first LangGraph.

In Example 3, the subject matter of Example 2 comprises, wherein the generating, by the interview AI agent, the plurality of questions is performed as a first node of a second LangGraph and wherein the generating of responses is performed by a second node of the second LangGraph.

In Example 4, the subject matter of Examples 1-3 comprises, wherein the operations further comprise: using a second large language model (LLM) to generate a process description of the runtime AI agent based on one or more responses to the plurality of questions received from a developer; using a third LLM to generate application code for the runtime AI agent based on the process description; and transferring the runtime AI agent to a runtime environment for execution by one or more end users, execution of the runtime AI agent causing manipulation of one or more software tools by a fourth LLM based on responses received from the one or more end users.

In Example 5, the subject matter of Example 4 comprises, wherein the process description is a Business Process Model and Notation (BPMN) file.

In Example 6, the subject matter of Examples 1-5 comprises, wherein content of a final message from the HPA is added as context for prompts to the interview AI agent.

In Example 7, the subject matter of Examples 1-6 comprises, wherein each time a question is posed to a persona of the HPA, context retrieved from the long-term memory of the HPA is added as contexts to prompts by the HPA.

Example 8 is a method comprising: generating a human proxy agent (HPA) by using a first LLM to generate a plurality of personas based on a text description of a task to solve, the HPA being an artificial intelligence (AI) agent; for each persona of the plurality of personas: prompting the first LLM to hallucinate details of a process based on a text description of a task; prompting the first LLM to generate example experiences of interactions between a corresponding persona and the task, based on the hallucinated details; prompting the first LLM to generate a grounding of a corresponding persona using the hallucinated details and the example experiences; storing the text description and the grounding of each of the plurality of personas in long-term memory of the HPA; generating, by an interview artificial intelligence (AI) agent, a plurality of questions regarding attributes of a runtime AI agent; generating responses to the plurality of questions by posing each of the plurality of questions to each persona of the HPA; and evaluating reliability of the interview AI agent based on the generated responses.

In Example 9, the subject matter of Example 8 comprises, wherein the using of the first LLM to generate the plurality of personas is performed as a first node of a first LangGraph, and wherein operations performed for each persona of the plurality of personas are performed as a second node of the first LangGraph.

In Example 10, the subject matter of Examples 8-9 comprises, wherein the generating, by the interview AI agent, the plurality of questions is performed as a first node of a second LangGraph and wherein the generating of responses is performed by a second node of the second LangGraph.

In Example 11, the subject matter of Examples 8-10 comprises, using a second large language model (LLM) to generate a process description of the runtime AI agent based on one or more responses to the plurality of questions received from a developer; using a third LLM to generate application code for the runtime AI agent based on the process description; and transferring the runtime AI agent to a runtime environment for execution by one or more end users, execution of the runtime AI agent causing manipulation of one or more software tools by a fourth LLM based on responses received from the one or more end users.

In Example 12, the subject matter of Example 11 comprises, wherein the process description is a Business Process Model and Notation (BPMN) file.

In Example 13, the subject matter of Examples 8-12 comprises, wherein content of a final message from the HPA is added as context for prompts to the interview AI agent.

In Example 14, the subject matter of Examples 8-13 comprises, wherein each time a question is posed to a persona of the HPA, context retrieved from the long-term memory of the HPA is added as contexts to prompts by the HPA.

Example 15 is a non-transitory machine-readable medium storing instructions which, when executed by one or more processors, cause the one or more processors to perform operations comprising: generating, by an interview artificial intelligence (AI) agent, a plurality of questions regarding attributes of a runtime AI agent; generating a human proxy agent (HPA) by using a first LLM to generate a plurality of personas based on a text description of a task to solve, the HPA being an artificial intelligence (AI) agent; for each persona of the plurality of personas: prompting the first LLM to hallucinate details of a process based a text description of a task; prompting the first LLM to generate example experiences of interactions between a corresponding persona and the task, based on the hallucinated details; prompting the first LLM to generate a grounding of a corresponding persona using the hallucinated details and the example experiences; storing the text description and the grounding of each of the plurality of personas in long-term memory of the HPA; generating, by an interview artificial intelligence (AI) agent, a plurality of questions regarding attributes of a runtime AI agent; generating responses to the plurality of questions by posing each of the plurality of questions to each persona of the HPA; and evaluating reliability of the interview AI agent based on the generated responses.

In Example 16, the subject matter of Example 15 comprises, wherein the using of the first LLM to generate the plurality of personas is performed as a first node of a first LangGraph, and wherein the operations performed for each persona of the plurality of personas are performed as a second node of the first LangGraph.

In Example 17, the subject matter of Example 16 comprises, wherein the generating, by the interview AI agent, the plurality of questions is performed as a first node of a second LangGraph and wherein the generating of responses is performed by a second node of the second LangGraph.

In Example 18, the subject matter of Examples 15-17 comprises, wherein the operations further comprise: using a second large language model (LLM) to generate a process description of the runtime AI agent based on one or more responses to the plurality of questions received from a developer; using a third LLM to generate application code for the runtime AI agent based on the process description; and transferring the runtime AI agent to a runtime environment for execution by one or more end users, execution of the runtime AI agent causing manipulation of one or more software tools by a fourth LLM based on responses received from the one or more end users.

In Example 19, the subject matter of Example 18 comprises, wherein the process description is a Business Process Model and Notation (BPMN) file.

In Example 20, the subject matter of Examples 15-19 comprises, wherein content of a final message from the HPA is added as context for prompts to the interview AI agent.

Example 21 is at least one machine-readable medium comprising instructions that, when executed by processing circuitry, cause the processing circuitry to perform operations to implement of any of Examples 1-20.

Example 22 is an apparatus comprising means to implement of any of Examples 1-20.

Example 23 is a system to implement of any of Examples 1-20.

Example 24 is a method to implement of any of Examples 1-20.

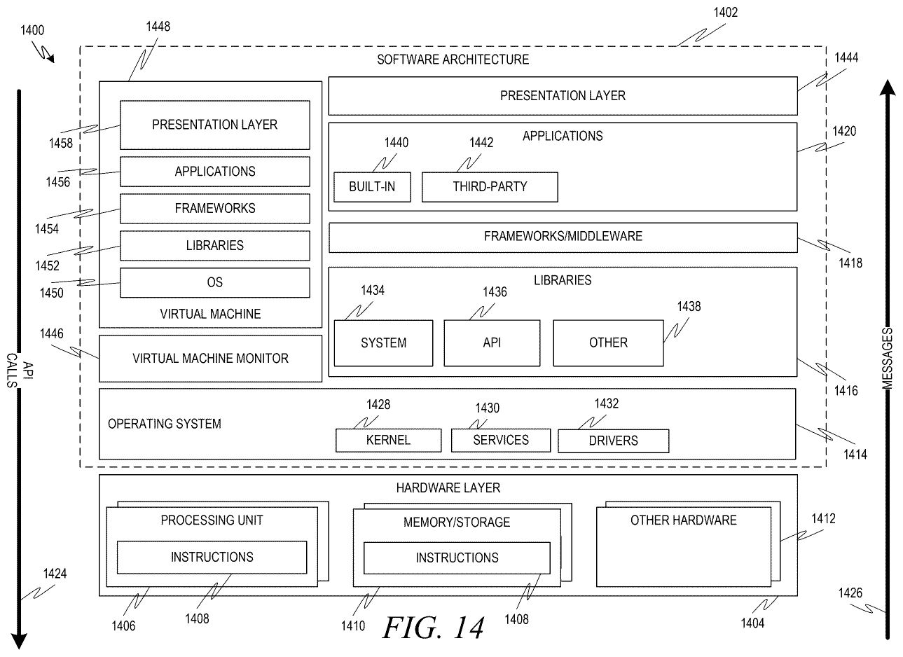

FIG. 14 shows a block diagram 1400 showing one example of a software architecture 1402 for a computing device. The software architecture 1402 may be used in conjunction with various hardware architectures, for example, as described herein. FIG. 14 is merely a non-limiting example of a software architecture, and many other architectures may be implemented to facilitate the functionality described herein. A representative hardware layer 1404 is illustrated and can represent, for example, any of the above referenced computing devices. In some examples, the hardware layer 1404 may be implemented according to the architecture of the computer system of FIG. 14.

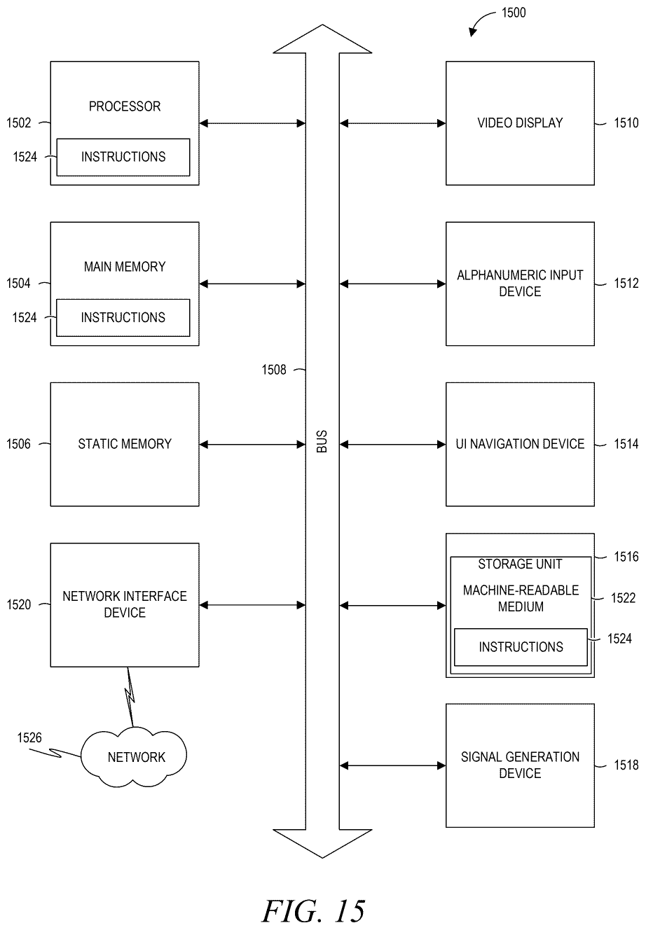

The representative hardware layer 1404 comprises one or more processing units 1406 having associated executable instructions 1408. Executable instructions 1408 represent the executable instructions of the software architecture 1402, including implementation of the methods, modules, subsystems, and components, and so forth described herein and may also include memory and/or storage modules 1410, which also have executable instructions 1408. Hardware layer 1404 may also comprise other hardware 1412 which represents any other hardware of the hardware layer 1404. Examples of the other hardware 1412 include the hardware components shown in FIG. 15.

In the example architecture of FIG. 14, the software architecture 1402 may be conceptualized as a stack of layers where each layer provides particular functionality. For example, the software architecture 1402 may include layers such as an operating system 1414, libraries 1416, frameworks/middleware 1418, applications 1420, and presentation layer 1444. Operationally, the applications 1420 and/or other components within the layers may invoke API calls 1424 through the software stack and access a response, returned values, and so forth illustrated as messages 1426 in response to the API calls 1424. The layers illustrated are representative in nature and not all software architectures have all layers. For example, some mobile or special purpose operating systems may not provide a frameworks/middleware 1418 layer, while others may provide such a layer. Other software architectures may include additional or different layers.

The operating system 1414 may manage hardware resources and provide common services. The operating system 1414 may include, for example, a kernel 1428, services 1430, and drivers 1432. The kernel 1428 may act as an abstraction layer between the hardware and the other software layers. For example, the kernel 1428 may be responsible for memory management, processor management (e.g., scheduling), component management, networking, security settings, and so on. The services 1430 may provide other common services for the other software layers. In some examples, the services 1430 include an interrupt service. The interrupt service may detect the receipt of an interrupt and, in response, cause the software architecture 1402 to pause its current processing and execute an interrupt service routine (ISR) when an interrupt is accessed.

The drivers 1432 may be responsible for controlling or interfacing with the underlying hardware. For instance, the drivers 1432 may include display drivers, camera drivers, Bluetooth® drivers, flash memory drivers, serial communication drivers (e.g., Universal Serial Bus (USB) drivers), Wi-Fi® drivers, NFC drivers, audio drivers, power management drivers, and so forth depending on the hardware configuration.

The libraries 1416 may provide a common infrastructure that may be utilized by the applications 1420 and/or other components and/or layers. The libraries 1416 typically provide functionality that allows other software modules to perform tasks in an easier fashion than to interface directly with the underlying operating system 1414 functionality (e.g., kernel 1428, services 1430 and/or drivers 1432). The libraries 1416 may include system libraries 1434 (e.g., C standard library) that may provide functions such as memory allocation functions, string manipulation functions, mathematic functions, and the like. In addition, the libraries 1416 may include API libraries 1436 such as media libraries (e.g., libraries to support presentation and manipulation of various media format such as MPEG4, H.264, MP3, AAC, AMR, JPG, PNG), graphics libraries (e.g., an OpenGL framework that may be used to render two-dimensional and three-dimensional in a graphic content on a display), database libraries (e.g., SQLite that may provide various relational database functions), web libraries (e.g., WebKit that may provide web browsing functionality), and the like. The libraries 1416 may also include a wide variety of other libraries 1438 to provide many other APIs to the applications 1420 and other software components/modules.

The frameworks/middleware 1418 may provide a higher-level common infrastructure that may be utilized by the applications 1420 and/or other software components/modules. For example, the frameworks/middleware 1418 may provide various graphic user interface (GUI) functions, high-level resource management, high-level location services, and so forth. The frameworks/middleware 1418 may provide a broad spectrum of other APIs that may be utilized by the applications 1420 and/or other software components/modules, some of which may be specific to a particular operating system or platform.

The applications 1420 include built-in applications 1440 and/or third-party applications 1442. Examples of representative built-in applications 1440 may include, but are not limited to, a contacts application, a browser application, a book reader application, a location application, a media application, a messaging application, and/or a game application. Third-party applications 1442 may include any of the built-in applications as well as a broad assortment of other applications. In a specific example, the third-party application 1442 (e.g., an application developed using the Android™ or iOS™ software development kit (SDK) by an entity other than the vendor of the particular platform) may be mobile software running on a mobile operating system such as iOS™, Android™, Windows® Phone, or other mobile computing device operating systems. In this example, the third-party application 1442 may invoke the API calls 1424 provided by the mobile operating system such as operating system 1414 to facilitate functionality described herein.

The applications 1420 may utilize built-in operating system functions (e.g., kernel 1428, services 1430 and/or drivers 1432), libraries (e.g., system libraries 1434, API libraries 1436, and other libraries 1438), and frameworks/middleware 1418 to create user interfaces to interact with users of the system. Alternatively, or additionally, in some systems, interactions with a user may occur through a presentation layer, such as presentation layer 1444. In these systems, the application/module “logic” can be separated from the aspects of the application/module that interact with a user.

Some software architectures utilize virtual machines. In the example of FIG. 14, this is illustrated by virtual machine 1448. A virtual machine creates a software environment where applications/modules can execute as if they were executing on a hardware computing device. A virtual machine is hosted by a host operating system (operating system 1414) and typically, although not always, has a virtual machine monitor 1446, which manages the operation of the virtual machine 1448 as well as the interface with the host operating system (i.e., operating system 1414). A software architecture executes within the virtual machine 1448 such as an operating system 1450, libraries 1452, frameworks/middleware 1454, applications 1456 and/or presentation layer 1458. These layers of software architecture executing within the virtual machine 1448 can be the same as corresponding layers previously described or may be different.

### Modules, Components and Logic

A computer system may include logic, components, modules, mechanisms, or any suitable combination thereof. Modules may constitute either software modules (e.g., code embodied (1) on a non-transitory machine-readable medium or (2) in a transmission signal) or hardware-implemented modules. A hardware-implemented module is a tangible unit capable of performing certain operations and may be configured or arranged in a certain manner. One or more computer systems (e.g., a standalone, client, or server computer system) or one or more hardware processors may be configured by software (e.g., an application or application portion) as a hardware-implemented module that operates to perform certain operations as described herein.

A hardware-implemented module may be implemented mechanically or electronically. For example, a hardware-implemented module may comprise dedicated circuitry or logic that is permanently configured (e.g., as a special-purpose processor, such as a field programmable gate array [FPGA] or an application-specific integrated circuit [ASIC]) to perform certain operations. A hardware-implemented module may also comprise programmable logic or circuitry (e.g., as encompassed within a general-purpose processor or another programmable processor) that is temporarily configured by software to perform certain operations. It will be appreciated that the decision to implement a hardware-implemented module mechanically, in dedicated and permanently configured circuitry, or in temporarily configured circuitry (e.g., configured by software) may be driven by cost and time considerations.

Accordingly, the term “hardware-implemented module” should be understood to encompass a tangible entity, be that an entity that is physically constructed, permanently configured (e.g., hardwired), or temporarily or transitorily configured (e.g., programmed) to operate in a certain manner and/or to perform certain operations described herein. Hardware-implemented modules may be temporarily configured (e.g., programmed), and each of the hardware-implemented modules need not be configured or instantiated at any one instance in time. For example, where the hardware-implemented modules comprise a general-purpose processor configured using software, the general-purpose processor may be configured as respective different hardware-implemented modules at different times. Software may accordingly configure a processor, for example, to constitute a particular hardware-implemented module at one instance of time and to constitute a different hardware-implemented module at a different instance of time.

Hardware-implemented modules can provide information to, and receive information from, other hardware-implemented modules. Accordingly, the described hardware-implemented modules may be regarded as being communicatively coupled. Where multiples of such hardware-implemented modules exist contemporaneously, communications may be achieved through signal transmission (e.g., over appropriate circuits and buses that connect the hardware-implemented modules). Multiple hardware-implemented modules are configured or instantiated at different times. Communications between such hardware-implemented modules may be achieved, for example, through the storage and retrieval of information in memory structures to which the multiple hardware-implemented modules have access. For example, one hardware-implemented module may perform an operation, and store the output of that operation in a memory device to which it is communicatively coupled. A further hardware-implemented module may then, at a later time, access the memory device to retrieve and process the stored output. Hardware-implemented modules may also initiate communications with input or output devices, and can operate on a resource (e.g., a collection of information).

The various operations of example methods described herein may be performed, at least partially, by one or more processors that are temporarily configured (e.g., by software) or permanently configured to perform the relevant operations. Whether temporarily or permanently configured, such processors may constitute processor-implemented modules that operate to perform one or more operations or functions. The modules referred to herein may comprise processor-implemented modules.

Similarly, the methods described herein may be at least partially processor-implemented. For example, at least some of the operations of a method may be performed by one or more processors or processor-implemented modules. The performance of certain of the operations may be distributed among the one or more processors, not only residing within a single machine, but deployed across a number of machines. The processor or processors may be located in a single location (e.g., within a home environment, an office environment, or a server farm), or the processors may be distributed across a number of locations.

The one or more processors may also operate to support performance of the relevant operations in a “cloud computing” environment or as a “software as a service” (SaaS). For example, at least some of the operations may be performed by a group of computers (as examples of machines including processors), these operations being accessible via a network (e.g., the Internet) and via one or more appropriate interfaces (e.g., APIs).

### Electronic Apparatus and System

The systems and methods described herein may be implemented using digital electronic circuitry, computer hardware, firmware, software, a computer program product (e.g., a computer program tangibly embodied in an information carrier, e.g., in a machine-readable medium for execution by, or to control the operation of, data processing apparatus, e.g., a programmable processor, a computer, or multiple computers), or any suitable combination thereof.

A computer program can be written in any form of programming language, including compiled or interpreted languages, and it can be deployed in any form, including as a standalone program or as a module, subroutine, or other unit suitable for use in a computing environment. A computer program can be deployed to be executed on one computer or on multiple computers at one site or distributed across multiple sites (e.g., cloud computing) and interconnected by a communication network. In cloud computing, the server-side functionality may be distributed across multiple computers connected by a network. Load balancers are used to distribute work between the multiple computers. Thus, a cloud computing environment performing a method is a system comprising the multiple processors of the multiple computers tasked with performing the operations of the method.

Operations may be performed by one or more programmable processors executing a computer program to perform functions by operating on input data and generating output. Method operations can also be performed by, and apparatus of systems may be implemented as, special purpose logic circuitry, e.g., an FPGA or an ASIC.

The computing system can include clients and servers. A client and server are generally remote from each other and typically interact through a communication network. The relationship of client and server arises by virtue of computer programs running on the respective computers and having a client-server relationship to each other. A programmable computing system may be deployed using hardware architecture, software architecture, or both. Specifically, it will be appreciated that the choice of whether to implement certain functionality in permanently configured hardware (e.g., an ASIC), in temporarily configured hardware (e.g., a combination of software and a programmable processor), or in a combination of permanently and temporarily configured hardware may be a design choice. Below are set out example hardware (e.g., machine) and software architectures that may be deployed.

### Example Machine Architecture and Machine-Readable Medium

FIG. 15 shows a block diagram of a machine in the example form of a computer system 1500 within which instructions 1524 may be executed for causing the machine to perform any one or more of the methodologies discussed herein. The machine may operate as a standalone device or may be connected (e.g., networked) to other machines. In a networked deployment, the machine may operate in the capacity of a server or a client machine in server-client network environment, or as a peer machine in a peer-to-peer (or distributed) network environment. The machine may be a personal computer (PC), a tablet PC, a set-top box (STB), a personal digital assistant (PDA), a cellular telephone, a web appliance, a network router, switch, or bridge, or any machine capable of executing instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein.

The example computer system 1500 includes a processor 1502 (e.g., a central processing unit [CPU], a graphics processing unit [GPU], or both), a main memory 1504, and a static memory 1506, which communicate with each other via a bus 1508. The computer system 1500 may further include a video display unit 1510 (e.g., a liquid crystal display [LCD] or a cathode ray tube [CRT]). The computer system 1500 also includes an alphanumeric input device 1512 (e.g., a keyboard or a touch-sensitive display screen), a user interface (UI) navigation (or cursor control) device 1514 (e.g., a mouse), a storage unit 1516, a signal generation device 1518 (e.g., a speaker), and a network interface device 1520.

### Machine-Readable Medium

The storage unit 1516 includes a machine-readable medium 1522 on which is stored one or more sets of data structures and instructions 1524 (e.g., software) embodying or utilized by any one or more of the methodologies or functions described herein. The instructions 1524 may also reside, completely or at least partially, within the main memory 1504 and/or within the processor 1502 during execution thereof by the computer system 1500, with the main memory 1504 and the processor 1502 also constituting a machine-readable medium 1522.

While the machine-readable medium 1522 is shown in FIG. 15 to be a single medium, the term “machine-readable medium” may include a single medium or multiple media (e.g., a centralized or distributed database, and/or associated caches and servers) that store the one or more instructions 1524 or data structures. The term “machine-readable medium” shall also be taken to include any tangible medium that is capable of storing, encoding, or carrying instructions 1524 for execution by the machine and that cause the machine to perform any one or more of the methodologies of the present disclosure, or that is capable of storing, encoding, or carrying data structures utilized by or associated with the instructions 1524. The term “machine-readable medium” shall accordingly be taken to include, but not be limited to, solid-state memories, and optical and magnetic media. Specific examples of machine-readable media include non-volatile memory, including by way of example semiconductor memory devices, e.g., erasable programmable read-only memory (EPROM), electrically erasable programmable read-only memory (EEPROM), and flash memory devices; magnetic disks such as internal hard disks and removable disks; magneto-optical disks; and compact disc read-only memory (CD-ROM) and digital versatile disc read-only memory (DVD-ROM) disks. A machine-readable medium is not a transmission medium.

### Transmission Medium

The instructions 1524 may further be transmitted or received over a communications network 1526 using a transmission medium. The instructions 1524 may be transmitted using the network interface device 1520 and any one of a number of well-known transfer protocols (e.g., hypertext transport protocol [HTTP]). Examples of communication networks include a local area network (LAN), a wide area network (WAN), the Internet, mobile telephone networks, plain old telephone (POTS) networks, and wireless data networks (e.g., WiFi and WiMax networks). The term “transmission medium” shall be taken to include any intangible medium that is capable of storing, encoding, or carrying instructions 1524 for execution by the machine, and includes digital or analog communications signals or other intangible media to facilitate communication of such software.

Although specific examples are described herein, it will be evident that various modifications and changes may be made to these examples without departing from the broader spirit and scope of the disclosure. Accordingly, the specification and drawings are to be regarded in an illustrative rather than a restrictive sense. The accompanying drawings that form a part hereof show by way of illustration, and not of limitation, specific examples in which the subject matter may be practiced. The examples illustrated are described in sufficient detail to enable those skilled in the art to practice the teachings disclosed herein.

Some portions of the subject matter discussed herein may be presented in terms of algorithms or symbolic representations of operations on data stored as bits or binary digital signals within a machine memory (e.g., a computer memory). Such algorithms or symbolic representations are examples of techniques used by those of ordinary skill in the data processing arts to convey the substance of their work to others skilled in the art. As used herein, an “algorithm” is a self-consistent sequence of operations or similar processing leading to a desired result. In this context, algorithms and operations involve physical manipulation of physical quantities. Typically, but not necessarily, such quantities may take the form of electrical, magnetic, or optical signals capable of being stored, accessed, transferred, combined, compared, or otherwise manipulated by a machine. It is convenient at times, principally for reasons of common usage, to refer to such signals using words such as “data,” “content,” “bits,” “values,” “elements,” “symbols,” “characters,” “terms,” “numbers,” “numerals,” or the like. These words, however, are merely convenient labels and are to be associated with appropriate physical quantities.

Unless specifically stated otherwise, discussions herein using words such as “processing,” “computing,” “calculating,” “determining,” “presenting,” “displaying,” or the like may refer to actions or processes of a machine (e.g., a computer) that manipulates or transforms data represented as physical (e.g., electronic, magnetic, or optical) quantities within one or more memories (e.g., volatile memory, non-volatile memory, or any suitable combination thereof), registers, or other machine components that receive, store, transmit, or display information. Furthermore, unless specifically stated otherwise, the terms “a” and “an” are herein used, as is common in patent documents, to include one or more than one instance. Finally, as used herein, the conjunction “or” refers to a non-exclusive “or,” unless specifically stated otherwise.

What is claimed is:

1. A system comprising:
at least one hardware processor;
a non-transitory computer-readable medium storing instructions that, when executed by the at least one hardware processor, cause the at least one hardware processor to perform operations comprising:
generating one or more human proxy agents (HPAs) by using a first LLM to generate a plurality of personas based on a text description of a task to solve, each HPA being an artificial intelligence (AI) agent;
for each persona of the plurality of personas:
prompting a second LLM to hallucinate details of a process based on a text description of a task;
prompting a third LLM to generate example experiences of interactions between a corresponding persona and the task, based on the hallucinated details;
prompting a fourth LLM to generate a grounding of a corresponding persona using the hallucinated details and the example experiences;
storing the text description and the grounding of each of the plurality of personas in long-term memory of the HPA;
generating, by a non-HPA artificial intelligence (AI) agent, a plurality of questions;
generating responses to the plurality of questions by posing each of the plurality of questions to each HPA; and
evaluating reliability of the non-HPA AI agent based on the generated responses.

2. The system of claim 1, wherein the using the first LLM to generate the plurality of personas is performed as a first node of a first LangGraph, and wherein the operations performed for each persona of the plurality of personas are performed as a second node of the first LangGraph.

3. The system of claim 2, wherein the generating, by the non-HPA AI agent, the plurality of questions is performed as a first node of a second LangGraph and wherein the generating responses is performed by a second node of the second LangGraph.

4. The system of claim 1, wherein the operations further comprise:
using a second large language model (LLM) to generate a process description of the runtime AI agent based on one or more responses to the plurality of questions received from a developer;
using a third LLM to generate application code for the runtime AI agent based on the process description; and
transferring the runtime AI agent to a runtime environment for execution by one or more end users, execution of the runtime AI agent causing manipulation of one or more software tools by a fourth LLM based on responses received from the one or more end users.

5. The system of claim 4, wherein the process description is a Business Process Model and Notation (BPMN) file.

6. The system of claim 1, wherein content of a final message from the HPA is added as context for prompts to the interview AI agent.

7. The system of claim 1, wherein each time a question is posed to a persona of the HPA, context retrieved from the long-term memory of the HPA is added as contexts to prompts by the HPA.

8. A method comprising:
generating one or more human proxy agents (HPAs) by using a first LLM to generate a plurality of personas based on a text description of a task to solve, each HPA being an artificial intelligence (AI) agent;
for each persona of the plurality of personas:
prompting a second LLM to hallucinate details of a process based on a text description of a task;
prompting a third LLM to generate example experiences of interactions between a corresponding persona and the task, based on the hallucinated details;
prompting a fourth LLM to generate a grounding of a corresponding persona using the hallucinated details and the example experiences;
storing the text description and the grounding of each of the plurality of personas in long-term memory of the HPA;
generating, by a non-HPA artificial intelligence (AI) agent, a plurality of questions;
generating responses to the plurality of questions by posing each of the plurality of questions to each HPA; and
evaluating reliability of the non-HPA AI agent based on the generated responses.

9. The method of claim 8, wherein the using the first LLM to generate the plurality of personas is performed as a first node of a first LangGraph, and wherein the operations performed for each persona of the plurality of personas are performed as a second node of the first LangGraph.

10. The method of claim 9, wherein the generating, by the non-HPA AI agent, the plurality of questions is performed as a first node of a second LangGraph and wherein the generating responses is performed by a second node of the second LangGraph.

11. The method of claim 8, wherein the operations further comprise:
using a second large language model (LLM) to generate a process description of the runtime AI agent based on one or more responses to the plurality of questions received from a developer;
using a third LLM to generate application code for the runtime AI agent based on the process description; and
transferring the runtime AI agent to a runtime environment for execution by one or more end users, execution of the runtime AI agent causing manipulation of one or more software tools by a fourth LLM based on responses received from the one or more end users.

12. The method of claim 11, wherein the process description is a Business Process Model and Notation (BPMN) file.

13. The method of claim 8, wherein content of a final message from the HPA is added as context for prompts to the interview AI agent.

14. The method of claim 8, wherein each time a question is posed to a persona of the HPA, context retrieved from the long-term memory of the HPA is added as contexts to prompts by the HPA.

15. A non-transitory machine-readable medium storing instructions which, when executed by one or more processors, cause the one or more processors to perform operations comprising:
generating one or more human proxy agents (HPAs) by using a first LLM to generate a plurality of personas based on a text description of a task to solve, each HPA being an artificial intelligence (AI) agent;
for each persona of the plurality of personas:
prompting a second LLM to hallucinate details of a process based on a text description of a task;
prompting a third LLM to generate example experiences of interactions between a corresponding persona and the task, based on the hallucinated details;
prompting a fourth LLM to generate a grounding of a corresponding persona using the hallucinated details and the example experiences;
storing the text description and the grounding of each of the plurality of personas in long-term memory of the HPA;
generating, by a non-HPA artificial intelligence (AI) agent, a plurality of questions;
generating responses to the plurality of questions by posing each of the plurality of questions to each HPA; and
evaluating reliability of the non-HPA AI agent based on the generated responses.

16. The non-transitory machine-readable medium of claim 15, wherein the using the first LLM to generate the plurality of personas is performed as a first node of a first LangGraph, and wherein the operations performed for each persona of the plurality of personas are performed as a second node of the first LangGraph.

17. The non-transitory machine-readable medium of claim 16, wherein the generating, by the non-HPA AI agent, the plurality of questions is performed as a first node of a second LangGraph and wherein the generating responses is performed by a second node of the second LangGraph.

18. The non-transitory machine-readable medium of claim 15, wherein the operations further comprise:
using a second large language model (LLM) to generate a process description of the runtime AI agent based on one or more responses to the plurality of questions received from a developer;
using a third LLM to generate application code for the runtime AI agent based on the process description; and
transferring the runtime AI agent to a runtime environment for execution by one or more end users, execution of the runtime AI agent causing manipulation of one or more software tools by a fourth LLM based on responses received from the one or more end users.

19. The non-transitory machine-readable medium of claim 18, wherein the process description is a Business Process Model and Notation (BPMN) file.

20. The non-transitory machine-readable medium of claim 15, wherein content of a final message from the HPA is added as context for prompts to the interview AI agent.
